(19) United States
(12) Patent Application Publication
(10) Pub. No.: US 2024/0365077 A1
(43) Pub. Date: Oct. 31, 2024

(54) APPARATUS AND METHOD FOR IMPLEMENTING VERSATILE AUDIO OBJECT RENDERING

(71) Applicant: Fraunhofer-Gesellschaft zur Förderung der angewandten Forschung e.V., München (DE)

(72) Inventors: Andreas WALTHER, Erlangen (DE); Hanne STENZEL, Erlangen (DE); Julian KLAPP, Erlangen (DE); Marvin TRÜMPER, Erlangen (DE); Christof FALLER, Greifensee (CH); Markus SCHMIDT, Lausanne (CH)

(73) Assignee: Fraunhofer-Gesellschaft zur Förderung der angewandten Forschung e.V., München (DE)

(21) Appl. No.: 18/764,318

(22) Filed: Jul. 4, 2024

Related U.S. Application Data
(63) Continuation of application No. PCT/EP2022/050101, filed on Jan. 4, 2022.

(51) Int. Cl. H04S 7/00

(52) U.S. Cl. CPC H04S 7/00; H04S 2400/11

(57) ABSTRACT

An apparatus for rendering according to an embodiment is provided. The apparatus is configured to generate an audio output signal for a loudspeaker of a loudspeaker setup from one or more audio objects. Each of the one or more audio objects comprises an audio object signal and exhibits a position. The apparatus comprises an interface configured to receive information on the position of each of the one or more audio objects. Moreover, the apparatus comprises a gain determiner configured to determine gain information for each audio object of the one or more audio objects for the loudspeaker depending on a distance between the position of said audio object and a position of the loudspeaker and depending on distance attenuation information and/or loudspeaker emphasis information. Furthermore, the apparatus comprises a signal processor configured to generate an audio output signal for the loudspeaker depending on the audio object signal of each of the one or more audio objects and depending on the gain information for each of the one or more audio objects for the loudspeaker.

### CROSS-REFERENCE TO RELATED APPLICATION

This application is a continuation of copending International Application No. PCT/EP2022/050101, filed Jan. 4, 2022, which is incorporated herein by reference in its entirety.

### BACKGROUND OF THE INVENTION

The present invention relates to the technical field of audio signal processing and audio reproduction. In particular, the present invention relates to the field of reproduction of spatial audio and describes an audio processor for rendering, more particularly, to an audio processor for rendering and, in particular, to an apparatus and a method for versatile audio object rendering.

Inter alia, the present invention relates to rendering and panning. Rendering or panning relates to the distribution of audio signals to different loudspeakers for producing the perception of auditory objects not only at the loudspeaker positions, but also at positions between the different loudspeakers. Such a distribution is usually called rendering or panning. In the following, both terms, rendering and panning may, e.g., be used interchangeably.

Usually rendering concepts assume that the reproduction setup comprises the same type of loudspeakers at all loudspeaker positions. Furthermore, it is usually assumed that those loudspeakers are capable of reproducing the complete audio frequency range and that all loudspeakers are available for the rendering of all input signals.

Conventional technology object renderers take the loudspeaker positions and object positions into account to render a listener-centric correct audio image with respect to the azimuth and elevation of the audio objects, but they cannot cope with distance rendering.

One of the most commonly used audio panning techniques is amplitude panning.

Stereo amplitude panning is a method to render an object to a position between two loudspeakers. The object's signal is provided to both loudspeakers with specific amplitude panning gains. These amplitude panning gains are usually computed as a function of loudspeaker and object positions or angles, relative to a listener position.

Object renderers for multi-channel and 3D loudspeaker setups are usually based on a similar concept. As a function of loudspeaker and object position or angles, gains are computed with which the object's signal is provided to the loudspeakers.

Often, two to four object-proximate loudspeakers (e.g., loudspeakers close to the intended object position) are selected over which the object is rendered. For example, loudspeakers in a direction opposite to the object direction are not used for rendering, or may, e.g., receive the object signal with zero gain.

State-of-the-art renderers operate relative to a sweet spot or listener position. When listener position changes and rendering is re-computed, frequently discontinuities occur. For example, amplitude panning gains are suddenly increasing or decreasing, or switching suddenly on or off.

Moreover, state-of-the-art renderers route audio signals to loudspeakers with different gains as a function of loudspeaker and object angles relative to listener. As only angles are considered, the renderers are not suitable for distance rendering.

Furthermore, state-of-the art renderers are initialized for a specific listener position. Every time a listener position changes, all loudspeaker angles and other data have to be recomputed. This adds substantial computational complexity when rendering for a moving listener, e.g., when tracked rendering is conducted.

State-of-the-art renderers do not take specifics of the loudspeakers comprising the actual reproduction setup into account.

Moreover, state-of-the-art renderers do not take specifics of the input signals or the input signal content type into account.

While some of the above limitations are described with respect to a (changing) listener position, all arguments are in the same way true if for an assumed fixed listener position the position(s) of one or more loudspeaker(s) change(s).

Some conventional technology systems are available that feature only small loudspeakers as main reproduction devices. Some available playback systems feature complex single devices such as a soundbar for the front channels, while the surround signals are played back over small satellite loudspeakers.

To compensate for the missing low frequency reproduction capabilities of the used small loudspeakers or soundbars, an additional subwoofer is often used, which is a loudspeaker dedicated for playing back of low frequencies only. This subwoofer is then used to reproduce the low frequencies, while the higher frequencies are reproduced by the main reproduction system in use such as the main loudspeakers or e.g. over the soundbar with associated satellite loudspeakers.

Usually, such systems divide the reproduced audio signals into a low frequency portion (which is routed to the subwoofer) and a high frequency portion (which is played back by the main loudspeakers or the soundbar).

Basically, some systems comprise a high-pass filter for each of the input channels and a corresponding/complementary low pass filter. The high pass part of the main channels is routed to the primary reproduction means (either e.g. small loudspeakers, or a soundbar), while the low-pass parts of all the channels plus a potentially available LFE input signal are routed to a subwoofer. Usually, the crossover frequency between the high-pass and the low-pass part is somewhere around 100 Hz (maybe between 80 Hz and 120 Hz, but that frequency is not exactly fixed/standardized and can be chosen by the system's manufacturer).

Usually, all low frequency content is then played back as a sum signal from one or more subwoofers.

Loudspeakers exist in different sizes and different quality levels. By this, also the reproducible frequency range is different for different types of loudspeakers.

In a home environment, likely only enthusiasts will install a high number of large loudspeakers needed to replicate the loudspeaker setups that are used in professional environments, research labs, or cinemas.

Often it is inconvenient or impossible to install large loudspeakers everywhere around a listening area or listening position. Specifically at top or bottom directions, smaller loudspeakers may be desired.

### SUMMARY

An embodiment may have an apparatus for rendering, wherein the apparatus is configured to generate an audio output signal for a loudspeaker of a loudspeaker setup from one or more audio objects, wherein each of the one or more audio objects comprises an audio object signal and exhibits a position, wherein the apparatus comprises: an interface configured to receive information on the position of each of the one or more audio objects, a gain determiner configured to determine gain information for each audio object of the one or more audio objects for the loudspeaker depending on a distance between the position of said audio object and a position of the loudspeaker and depending on distance attenuation information and/or loudspeaker emphasis information, and a signal processor configured to generate an audio output signal for the loudspeaker depending on the audio object signal of each of the one or more audio objects and depending on the gain information for each of the one or more audio objects for the loudspeaker.

Another embodiment may have an apparatus for rendering, wherein the apparatus comprises: a processing module configured to assign each loudspeaker of the two or more loudspeakers to one or more loudspeaker subset groups of the two or more loudspeaker subset groups depending on one or more capabilities and/or a position of said loudspeaker, wherein at least one of the two or more loudspeakers is associated with fewer than all of the two or more loudspeaker subset groups, wherein the processing module is configured to associate each audio object signal of two or more audio object signals with at least one of two or more loudspeaker subset groups depending on a property of the audio object signal, such that at least one of the two or more audio object signals is associated with fewer than all of the two or more loudspeaker subset groups, wherein, for each loudspeaker subset group of the two or more loudspeaker subset groups, the processing module is configured to generate for each loudspeaker of said loudspeaker subset group a loudspeaker component signal for each audio object of those of the two or more audio objects which are associated with said loudspeaker subset group depending on a position of said loudspeaker and depending on a position of said audio object, wherein the processing module is configured to generate a loudspeaker signal for each loudspeaker of at least one of the two or more loudspeakers by combining all loudspeaker component signals of said loudspeaker of all loudspeaker subset groups to which said loudspeaker is assigned

Another embodiment may have a method for rendering, wherein the method comprises generating an audio output signal for a loudspeaker of a loudspeaker setup from one or more audio objects, wherein each of the one or more audio objects comprises an audio object signal and exhibits a position, wherein generating the audio output signal comprises: receiving information on the position of each of the one or more audio objects, determining gain information for each audio object of the one or more audio objects for the loudspeaker depending on a distance between the position of said audio object and a position of the loudspeaker and depending on distance attenuation information and/or loudspeaker emphasis information, and generating an audio output signal for the loudspeaker depending on the audio object signal of each of the one or more audio objects and depending on the gain information for each of the one or more audio objects for the loudspeaker.

Another embodiment may have a method for rendering is provided, wherein the method comprises: assigning each loudspeaker of the two or more loudspeakers of a loudspeaker setup to one or more loudspeaker subset groups of the two or more loudspeaker subset groups depending on one or more capabilities and/or a position of said loudspeaker, wherein at least one of the two or more loudspeakers is associated with fewer than all of the two or more loudspeaker subset groups, associating each audio object signal of two or more audio object signals with at least one of two or more loudspeaker subset groups depending on a property of the audio object signal, such that at least one of the two or more audio object signals is associated with fewer than all of the two or more loudspeaker subset groups, wherein, for each loudspeaker subset group of the two or more loudspeaker subset groups, the method comprises generating for each loudspeaker of said loudspeaker subset group a loudspeaker component signal for each audio object of those of the two or more audio objects which are associated with said loudspeaker subset group depending on a position of said loudspeaker and depending on a position of said audio object, wherein the method comprises generating a loudspeaker signal for each loudspeaker of at least one of the two or more loudspeakers by combining all loudspeaker component signals of said loudspeaker of all loudspeaker subset groups to which said loudspeaker is assigned.

Another embodiment may have a non-transitory digital storage medium having a computer program stored thereon to perform the method for rendering, wherein the method comprises generating an audio output signal for a loudspeaker of a loudspeaker setup from one or more audio objects, wherein each of the one or more audio objects comprises an audio object signal and exhibits a position, wherein generating the audio output signal comprises: receiving information on the position of each of the one or more audio objects, determining gain information for each audio object of the one or more audio objects for the loudspeaker depending on a distance between the position of said audio object and a position of the loudspeaker and depending on distance attenuation information and/or loudspeaker emphasis information, and generating an audio output signal for the loudspeaker depending on the audio object signal of each of the one or more audio objects and depending on the gain information for each of the one or more audio objects for the loudspeaker, when said computer program is run by a computer.

Another embodiment may have a non-transitory digital storage medium having a computer program stored thereon to perform the method for rendering is provided, wherein the method comprises: assigning each loudspeaker of the two or more loudspeakers of a loudspeaker setup to one or more loudspeaker subset groups of the two or more loudspeaker subset groups depending on one or more capabilities and/or a position of said loudspeaker, wherein at least one of the two or more loudspeakers is associated with fewer than all of the two or more loudspeaker subset groups, associating each audio object signal of two or more audio object signals with at least one of two or more loudspeaker subset groups depending on a property of the audio object signal, such that at least one of the two or more audio object signals is associated with fewer than all of the two or more loudspeaker subset groups, wherein, for each loudspeaker subset group of the two or more loudspeaker subset groups, the method comprises generating for each loudspeaker of said loudspeaker subset group a loudspeaker component signal for each audio object of those of the two or more audio objects which are associated with said loudspeaker subset group depending on a position of said loudspeaker and depending on a position of said audio object, wherein the method comprises generating a loudspeaker signal for each loudspeaker of at least one of the two or more loudspeakers by combining all loudspeaker component signals of said loudspeaker of all loudspeaker subset groups to which said loudspeaker is assigned, when said computer program is run by a computer.

An apparatus for rendering according to an embodiment is provided. The apparatus is configured to generate an audio output signal for a loudspeaker of a loudspeaker setup from one or more audio objects. Each of the one or more audio objects comprises an audio object signal and exhibits a position. The apparatus comprises an interface configured to receive information on the position of each of the one or more audio objects. Moreover, the apparatus comprises a gain determiner configured to determine gain information for each audio object of the one or more audio objects for the loudspeaker depending on a distance between the position of said audio object and a position of the loudspeaker and depending on distance attenuation information and/or loudspeaker emphasis information. Furthermore, the apparatus comprises a signal processor configured to generate an audio output signal for the loudspeaker depending on the audio object signal of each of the one or more audio objects and depending on the gain information for each of the one or more audio objects for the loudspeaker.

Moreover, an apparatus for rendering is provided. The apparatus comprises a processing module configured to assign each loudspeaker of two or more loudspeakers of a loudspeaker setup to one or more loudspeaker subset groups of the two or more loudspeaker subset groups depending on the one or more capabilities and/or a position of said loudspeaker, wherein at least one of the two or more loudspeakers is associated with fewer than all of the two or more loudspeaker subset groups. The processing module is configured to associate each audio object signal of two or more audio object signals with at least one of two or more loudspeaker subset groups depending on a property of the audio object signal, such that at least one of the two or more audio object signals is associated with fewer than all of the two or more loudspeaker subset groups. For each loudspeaker subset group of the two or more loudspeaker subset groups, the processing module is configured to generate for each loudspeaker of said loudspeaker subset group a loudspeaker component signal for each audio object of those of the two or more audio objects which are associated with said loudspeaker subset group depending on a position of said loudspeaker and depending on a position of said audio object. Moreover, the processing module is configured to generate a loudspeaker signal for each loudspeaker of at least one of the two or more loudspeakers by combining all loudspeaker component signals of said loudspeaker of all loudspeaker subset groups to which said loudspeaker is assigned.

Furthermore, a method for rendering according to an embodiment is provided. The method comprises generating an audio output signal for a loudspeaker of a loudspeaker setup from one or more audio objects, wherein each of the one or more audio objects comprises an audio object signal and exhibits a position, wherein generating the audio output signal comprises:
Receiving information on the position of each of the one or more audio objects.
Determining gain information for each audio object of the one or more audio objects for the loudspeaker depending on a distance between the position of said audio object and a position of the loudspeaker and depending on distance attenuation information and/or loudspeaker emphasis information. And:
Generating an audio output signal for the loudspeaker depending on the audio object signal of each of the one or more audio objects and depending on the gain information for each of the one or more audio objects for the loudspeaker.

Moreover, another method for rendering is provided. The method comprises:
Assigning each loudspeaker of two or more loudspeakers of a loudspeaker setup to one or more loudspeaker subset groups of the two or more loudspeaker subset groups depending on one or more capabilities and/or a position of said loudspeaker, wherein at least one of the two or more loudspeakers is associated with fewer than all of the two or more loudspeaker subset groups.
Associating each audio object signal of two or more audio object signals with at least one of two or more loudspeaker subset groups depending on a property of the audio object signal, such that at least one of the two or more audio object signals is associated with fewer than all of the two or more loudspeaker subset groups.

For each loudspeaker subset group of the two or more loudspeaker subset groups, the method comprises generating for each loudspeaker of said loudspeaker subset group a loudspeaker component signal for each audio object of those of the two or more audio objects which are associated with said loudspeaker subset group depending on a position of said loudspeaker and depending on a position of said audio object. Moreover, the method comprises generating a loudspeaker signal for each loudspeaker of at least one of the two or more loudspeakers by combining all loudspeaker component signals of said loudspeaker of all loudspeaker subset groups to which said loudspeaker is assigned.

Furthermore, computer programs are provided, wherein each of the computer programs is configured to implement one of the above-described methods when being executed on a computer or signal processor.

Some embodiments do not only take the loudspeaker positions and object positions into account for rendering, but may, e.g., also support distance rendering.

According to some embodiments, metadata is delivered together with the object-based audio input signals.

Furthermore, some embodiments support a free positioning and a free combination of a huge range of differently sized loudspeakers in an arbitrary arrangement. For example, in some embodiments, linkable (portable) loudspeakers or smart speakers may, e.g., be employed which allow arbitrary combinations of speakers of different capabilities at arbitrary positions.

When in the following, reference is made to a loudspeaker or loudspeakers, the term may relate to devices like smart speakers, soundbars, boom boxes, arrays of loudspeakers, TVs (e.g., TV loudspeakers), and other loudspeakers.

Some embodiments provide a system for reproducing audio signals in a sound reproduction system comprising a variable number of (potentially different kinds of) loudspeakers at arbitrary positions. An input to this rendering system may, e.g., be audio data with associated metadata, wherein the metadata may, e.g., describe specifics of the playback setup.

According to embodiments, high quality, faithful playback of the input audio signals over arbitrary loudspeaker setups is provided that takes specifics of the audio content/audio objects into account and that are to be rendered and tailored to the actually present playback setup in an advantageous, e.g., best possible way.

Some embodiments support rendering object distances depending on known positions of all loudspeakers in an actual reproduction setup and depending on the known intended object positions.

According to some embodiments, a system, apparatus and method are provided with a new parameterizable panning approach, wherein the system/apparatus/method employs a multi-adaptation approach to change the parameters of the renderer to achieve specific rendering results for different input signal types.

Usually, panning concepts assume that loudspeakers are positioned around a predefined listening area or ideal listening position/sweet spot and are optimized for this predefined listening area. While the proposed rendering concepts may, in some embodiments, e.g., be employed for standard loudspeaker arrangements, according to some embodiments, the proposed rendering concepts may, e.g., be employed for rendering audio for loudspeaker arrangements having and arbitrary number of loudspeakers at arbitrary positions. In particular embodiments, loudspeaker setups may, e.g., be employed that may, e.g., be spread out over a wide area and do not have a specifically defined listening area or sweet spot.

Some particular embodiments may, e.g., be employed in specific environments such as automotive audio rendering.

In some embodiments, efficient rendering in environments with changing loudspeaker setups is provided, e.g., in situations in which loudspeakers are added, removed or repositioned regularly. The adaptation to every change may, for example, happen in real-time.

Some embodiments may, e.g., be parameterizable. Such embodiments may, e.g., offer parameters that allow a controlled adaptation of the rendering result. This may, e.g. be useful, in particular, to achieve different rendering results for different input signal types.

According to some embodiments, specifics of the input signals and/or specifics or actual positions of the loudspeakers that are used in the actually present reproduction setup may, e.g., be taken into account for rendering.

Exemplary non-limiting use cases of such an adaptation may, for example, be one of the following: If the reproduction setup comprises, for example, loudspeakers of different sizes, where the larger ones are e.g. capable of playing back the complete audio frequency range, while the smaller ones are only capable of reproducing only a narrow frequency range, this difference in the loudspeakers' frequency responses may, e.g., be taken into account, and the multi-adaptation rendering may, e.g., perform a multi-band rendering.

If, for example, the input audio signal comprises different types of signals, for example, direct sound signals and ambient signals, the rendering system may, for example, perform the rendering such that different sets of loudspeakers may, e.g., be used to render the direct signals and the ambient signals. The selection of the loudspeakers that are used for each signal type may, for example, be selected depending on rules which may, e.g., take a spatial position and/or a spatial distribution and/or a spatial relation of the loudspeakers with respect to each other into account, or, for example, the loudspeaker's specific suitability for one signal type (e.g., dipole loudspeaker for ambience) into account. The parameters of the renderer may, e.g., be adapted accordingly for each signal type.

If, for example, the input audio signal is a speech signal, the parameters of the renderer may, for example, be set such that an advantageous (e.g., best possible) speech intelligibility may, e.g., be achieved or preserved.

If, for example, the audio input signals comprise object audio and channel-based audio, a different selection of the loudspeakers used for reproduction, and accordingly a different parameterization of the respective renderers may, for example, be employed for object input and channel-based input.

In embodiments, technical limitations of previously described rendering concepts are overcome. Some embodiments may, e.g., facilitate beneficial rendering in arbitrary reproduction setups with loudspeakers of potentially different specifications at varying positions and/or may, e.g., facilitate distance rendering.

### BRIEF DESCRIPTION OF THE DRAWINGS

Embodiments of the present invention will be detailed subsequently referring to the appended drawings, in which:

FIG. 1 illustrates an apparatus for rendering according to an embodiment.

FIG. 2 illustrates a renderer according to an embodiment.

FIG. 3 illustrates the rendering gains of a basis function with respect to target object positions for a sound system with six randomly positioned loudspeakers according to an embodiment.

FIG. 4 illustrates the rendering gains of a basis function with respect to target object positions for a sound system with six randomly positioned loudspeakers according to an embodiment, wherein αᵢ is set to αᵢ=1.

FIG. 5 illustrates the rendering gains of an example according to an embodiment, wherein three loudspeakers are positioned on a line with αᵢ=1.

FIG. 6 illustrates the rendering gains of a basis function with respect to target object positions for a sound system with six randomly positioned loudspeakers according to a further embodiment with αᵢ=2.

FIG. 7 illustrates the rendering gains of an example according to an embodiment, wherein three loudspeakers are positioned on a line with αᵢ=2.

FIG. 8 illustrates the rendering gains of a basis function with respect to target object positions for a sound system with six randomly positioned loudspeakers according to another embodiment with αᵢ=0.5.

FIG. 9 illustrates the rendering gains of an example according to an embodiment, wherein three loudspeakers that are positioned on a line with αᵢ=0.5 and Gᵢ=0 dB.

FIG. 10 illustrates the rendering gains of a basis function with respect to target object positions for a sound system with six randomly positioned loudspeakers according to another embodiment, wherein αᵢ is set to αᵢ=0.5 for i=1, 2, 3, 4, wherein αᵢ is set to αᵢ=2 for i=5, 6 and wherein Gᵢ=0 dB.

FIG. 11 illustrates the rendering gains of an example according to an embodiment, wherein three loudspeakers that are positioned on a line with αᵢ=0.5 for i=1, 3, with αᵢ=2 for i=2 and with Gᵢ=0 dB.

FIG. 12 illustrates the rendering gains of a basis function with respect to target object positions for a sound system with six randomly positioned loudspeakers according to a further embodiment, wherein αᵢ is set to αᵢ=1, wherein Gᵢ=10 dB for i=1, 2, 3, 4, and wherein Gᵢ=0 dB for i=5, 6.

FIG. 13 illustrates the rendering gains of an example according to an embodiment, wherein three loudspeakers that are positioned on a line with a, =1, wherein Gᵢ=10 dB for i=1, 3, and wherein Gᵢ=0 dB for i=2.

FIG. 14 illustrates an apparatus for rendering according to another embodiment.

FIG. 15 illustrates a particular loudspeaker arrangement and a multi-instance concept according to an embodiment.

FIG. 16 indicates a loudspeaker setup comprising loudspeaker wherein true loudspeaker positions are mapped onto a unit circle around a listening position according to an embodiment.

FIG. 17 illustrates, how concepts according to an embodiment may, e.g., be employed to conduct distance rendering in arbitrary loudspeaker setups.

FIG. 18 illustrates an example for a rendering approach according to an embodiment, when the actual listener position is tracked.

FIG. 19 illustrates an example for a rendering approach according to another embodiment, when the actual listener position is tracked.

### DETAILED DESCRIPTION OF THE INVENTION

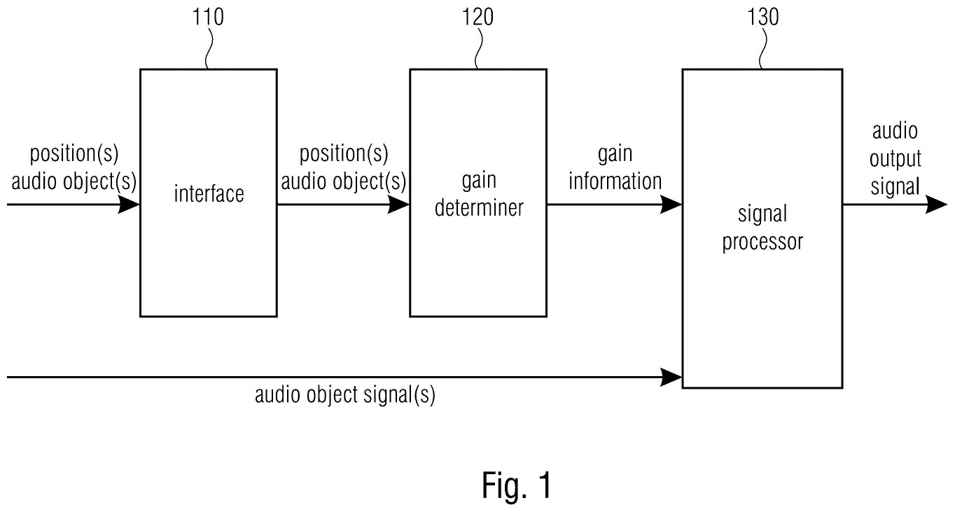

FIG. 1 illustrates an apparatus for rendering according to an embodiment.

The apparatus is configured to generate an audio output signal for a loudspeaker of a loudspeaker setup from one or more audio objects. Each of the one or more audio objects comprises an audio object signal and exhibits a position.

The apparatus comprises an interface 110 configured to receive information on the position of each of the one or more audio objects.

Moreover, the apparatus comprises a gain determiner 120 configured to determine gain information for each audio object of the one or more audio objects for the loudspeaker depending on a distance between the position of said audio object and a position of the loudspeaker and depending on distance attenuation information and/or loudspeaker emphasis information.

Furthermore, the apparatus comprises a signal processor 130 configured to generate an audio output signal for the loudspeaker depending on the audio object signal of each of the one or more audio objects and depending on the gain information for each of the one or more audio objects for the loudspeaker.

According to an embodiment, the gain determiner 120 may, e.g., be configured to determine the gain information for each audio object of the one or more audio objects depending on the distance attenuation information.

In an embodiment, the interface 110 may, e.g., be configured to receive metadata information. The gain determiner 120 may, e.g., be configured to determine the distance attenuation information from the metadata information.

According to an embodiment, when the distance attenuation information indicates that a distance between the position of an audio object of the one or more audio objects and the position of the loudspeaker shall have a greater influence on an attenuation of said audio object in the audio output signal, the gain determiner 120 may, e.g., be configured to attenuate the audio object signal of said audio object more or to amplify the audio object signal of said audio object less for generating the audio output signal, compared to when the distance attenuation information indicates that distance between the position of said audio object and the position of the loudspeaker shall have a smaller influence on the attenuation of said audio object in the audio output signal.

In an embodiment, the apparatus may, e.g., be configured to generate the audio output signal for the loudspeaker from the one or more audio objects being two or more audio objects. The interface 110 may, e.g., be configured to receive information on the position of each of two or more audio objects. The gain determiner 120 may, e.g., be configured to determine gain information for each audio object of the two or more audio objects for the loudspeaker depending on a distance between the position of said audio object and the position of the loudspeaker and depending on the distance attenuation information. The signal processor 130 may, e.g., be configured to generate the audio output signal for the loudspeaker depending on the audio output signal of each of the two or more audio objects and depending on the gain information for each of the two or more audio objects for the loudspeaker.

According to an embodiment, the distance attenuation information may, e.g., indicate, for each audio object of the two or more audio objects, a same influence of a distance between a position of the loudspeaker and a position of said audio object on the determining of the gain information.

In an embodiment, the distance attenuation information may, e.g., comprise a single distance attenuation parameter indicating the distance attenuation information for all of the two or more audio objects.

According to an embodiment, the distance attenuation information may, e.g., indicate, for at least two audio objects of the two or more audio objects, that an influence of a distance between a position of the loudspeaker and a position of one of the at least two audio objects on the determining of the gain information is different for the at least two audio objects.

In an embodiment, the distance attenuation information may, e.g., comprise at least two different distance attenuation parameters, wherein the at least two different distance attenuation parameters indicate different distance attenuation information for the at least two audio objects.

According to an embodiment, the interface 110 may, e.g., be configured to receive metadata indicating whether an audio object of the two or more audio objects is a speech audio object or whether said audio object is a non-speech audio object, and the gain determiner 120 may, e.g., be configured to determine the distance attenuation information depending on whether said audio object is a speech audio object or whether said audio object is a non-speech audio object. And/or, the apparatus may, e.g., be configured to determine whether an audio object of the two or more audio objects is a speech audio object or whether said audio object is a non-speech audio object depending on the audio object signal of said audio object, and the gain determiner 120 may, e.g., be configured to determine the distance attenuation information depending on whether said audio object is a speech audio object or whether said audio object is a non-speech audio object.

In an embodiment, the interface 110 may, e.g., be configured to receive metadata indicating whether an audio object of the two or more audio objects is a direct signal audio object or whether said audio object is an ambient signal audio object, and the gain determiner 120 may, e.g., be configured to determine the distance attenuation information depending on whether said audio object is a direct signal audio object or whether said audio object is an ambient audio object. And/or, the apparatus may, e.g., be configured to determine whether an audio object of the two or more audio objects is a direct signal audio object or whether said audio object is an ambient signal audio object depending on the audio object signal of said audio object, and the gain determiner 120 may, e.g., be configured to determine the distance attenuation information depending on whether said audio object is a direct signal audio object or whether said audio object is an ambient signal audio object.

According to an embodiment, the loudspeaker may, e.g., be a first loudspeaker. The loudspeaker setup may, e.g., comprise the first loudspeaker and one or more further loudspeakers as two or more loudspeakers. The distance attenuation information comprises distance attenuation information for the first loudspeaker. The interface 110 may, e.g., be configured to receive an indication on a capability and/or a position of each of the one or more further loudspeakers. The gain determiner 120 may, e.g., be configured to determine the distance attenuation information for the first loudspeaker depending on a capability and/or a position of the first loudspeaker and depending on the indication on the capability and/or the position of each of the one or more further loudspeakers. The gain determiner 120 may, e.g., be configured to determine the gain information depending on the distance attenuation information for the first loudspeaker.

In an embodiment, the gain determiner 120 may, e.g., be configured to determine the distance attenuation information for the first loudspeaker depending on a signal property of an audio object signal of at least one of the one or more audio objects, and/or depending on a position of at least one of the one or more audio objects.

According to an embodiment, the distance attenuation information comprises distance attenuation information for each of the one or more further loudspeakers. The gain determiner 120 may, e.g., be configured to determine the distance attenuation information for each of the one or more further loudspeakers depending on the capability and/or the position of the first loudspeaker and depending on the indication on the capability and/or the position of each of the one or more further loudspeakers. The gain determiner 120 is configured to determine the gain information depending on the distance attenuation information for each of the one or more further loudspeakers.

In an embodiment, the gain determiner 120 may, e.g., be configured to determine the distance attenuation information for each of the one or more further loudspeakers depending on a signal property of an audio object signal of at least one of the one or more audio objects, and/or depending on a position of at least one of the one or more audio objects.

According to an embodiment, the gain determiner 120 may, e.g., be configured to determine the gain information for each audio object of the one or more audio objects depending on the loudspeaker emphasis information.

In an embodiment, the interface 110 may, e.g., be configured to receive metadata information. The gain determiner 120 may, e.g., be configured to determine the loudspeaker emphasis information from the metadata information.

In an embodiment, when the loudspeaker emphasis information for the loudspeaker indicates that that the loudspeaker shall be amplified less or attenuated more, the gain determiner 120 may, e.g., be configured to attenuate the audio object signal of the audio object more or to amplify the audio object signal of the audio object less for generating the audio output signal for the loudspeaker, compared to when the loudspeaker emphasis information for the loudspeaker indicates that the loudspeaker shall be attenuated less or amplified more.

According to an embodiment, the loudspeaker may, e.g., be a first loudspeaker. The loudspeaker setup may, e.g., comprise the first loudspeaker and one or more further loudspeakers as two or more loudspeakers. The loudspeaker emphasis information may, e.g., comprise loudspeaker emphasis information for the first loudspeaker. The interface 110 may, e.g., be configured to receive an indication on a capability and/or a position of each of the one or more further loudspeakers. The gain determiner 120 may, e.g., be configured to determine the loudspeaker emphasis information for the first loudspeaker depending on a capability and/or a position of the first loudspeaker and depending on the indication on the capability and/or the position of each of the one or more further loudspeakers.

In an embodiment, the gain determiner 120 may, e.g., be configured to determine the loudspeaker emphasis information for the first loudspeaker depending on a signal property of an audio object signal of at least one of the one or more audio objects, and/or depending on a position of at least one of the one or more audio objects.

According to an embodiment, the loudspeaker emphasis information may, e.g., comprise loudspeaker emphasis information for each of the one or more further loudspeakers. The gain determiner 120 may, e.g., be configured to determine the loudspeaker emphasis information for each of the one or more further loudspeakers depending on the capability and/or the position of the first loudspeaker and depending on the indication on the capability and/or the position of each of the one or more further loudspeakers. The gain determiner (120) is configured to determine the gain information depending on the loudspeaker emphasis information for each of the one or more further loudspeakers.

In an embodiment, the gain determiner 120 may, e.g., be configured to determine the loudspeaker emphasis information for each of the one or more further loudspeakers depending on a signal property of an audio object signal of at least one of the one or more audio objects, and/or depending on a position of at least one of the one or more audio objects.

In an embodiment, the loudspeaker setup may, e.g., comprise the first loudspeaker and one or more further loudspeakers as two or more loudspeakers. The metadata information may, e.g., comprise an indication on a capability or a position of each of the one or more further loudspeakers. The gain determiner 120 may, e.g., be configured to determine the loudspeaker emphasis information for the first loudspeaker depending on the indication on the capability or the position of each of the one or more further loudspeakers.

According to an embodiment, the loudspeaker may, e.g., be a first loudspeaker. The loudspeaker setup comprises the first loudspeaker and one or more further loudspeakers as two or more loudspeakers. The metadata information comprises an indication on loudspeaker emphasis information for each of the two or more loudspeakers. The gain determiner 120 may, e.g., be configured to determine the loudspeaker emphasis information for the first loudspeaker from the metadata information.

In an embodiment, the gain determiner 120 may, e.g., be configured to determine the loudspeaker emphasis information for each of the two or more loudspeakers from the metadata information. The gain determiner 120 may, e.g., be configured to determine gain information for each audio object of the one or more audio objects for each loudspeaker of the two or more loudspeakers depending on the distance between the position of said audio object and the position of said loudspeaker, depending on the distance attenuation information and further depending on the loudspeaker emphasis information for said loudspeaker.

According to an embodiment, the signal processor 130 may, e.g., be configured to generate an audio output signal for each of the two or more loudspeakers depending on the audio object signal of each of the one or more audio objects and depending on the gain information for each of the one or more audio objects for said loudspeaker.

In an embodiment, the interface 110 may, e.g., be adapted to receive loudspeaker emphasis information that indicates, for each loudspeaker of the two or more loudspeaker, same attenuation or amplification information for each of the two or more loudspeakers for the determining of the gain information.

According to an embodiment, the interface 110 may, e.g., be adapted to receive the loudspeaker emphasis information comprising a single loudspeaker emphasis parameter indicating the attenuation or amplification information for each of the two or more loudspeakers.

In an embodiment, the interface 110 may, e.g., be adapted to receive loudspeaker emphasis information which indicates, for at least two audio objects of the two or more audio objects, that the attenuation or amplification information for the at least two loudspeakers for the determining of the gain information may, e.g., be different.

According to an embodiment, the interface 110 may, e.g., be adapted to receive the loudspeaker emphasis information comprising at least two different loudspeaker emphasis parameters, wherein the at least two different loudspeaker emphasis parameters indicate different loudspeaker emphasis information for the at least two loudspeakers.

In an embodiment, a first one of the at least two loudspeakers may, e.g., be a first type of loudspeaker. A second one of the at least two loudspeakers may, e.g., be a second type of loudspeaker.

According to an embodiment, the gain determiner 120 may, e.g., be configured to determine the gain information for each audio object of the one or more audio objects for the loudspeaker depending on the formula:

$${g}_{ik} = \frac{{q}_{k} {G}_{ik}}{{( {r}_{ik} )}^{{α}_{ik}}} ,$$

i is a first index indicating an i-th loudspeaker of the two or more loudspeakers,
k is a second index indicating a k-th audio object of the two or more audio objects,
rᵢₖ indicates a distance between the i-th loudspeaker and the k-th audio object,
αᵢₖ indicates the distance attenuation information for the k-th audio object for the i-th loudspeaker,
wherein Gᵢₖ indicates the loudspeaker emphasis information for the k-th audio object for the i-th loudspeaker,
wherein qₖ indicates a normalization factor

According to an embodiment, qₖ may, e.g., be defined depending on:

$${q}_{k} = \frac{1}{\sqrt{{\sum }_{i} \frac{{G}_{ik}^{2}}{{( {r}_{ik} )}^{2 {α}_{ik}}}}} ,$$

According to an embodiment, the apparatus is configured to receive information on that another loudspeaker being different from the two or more loudspeaker indicates its intention to reproducing audio content of the two or more object signals, and wherein, in response to said information, the gain determiner 120 may, e.g., be configured to determine the distance attenuation information and/or the loudspeaker emphasis information depending on a capability and/or a position of said other loudspeaker.

In an embodiment, the apparatus is configured to receive information on that one of the two or more loudspeakers is to stop or has stopped reproducing audio content of the two or more object signals, and wherein, in response to said information the gain determiner 120 may, e.g., be configured to determine the distance attenuation information and/or the loudspeaker emphasis information depending on a capability and/or a position of each of one or more remaining loudspeakers of the two or more loudspeakers.

According to an embodiment, the apparatus is configured to receive information on that the position of one of the two or more loudspeakers has changed, and wherein, in response to said information the gain determiner 120 may, e.g., be configured to determine the distance attenuation information and/or the loudspeaker emphasis information depending on a capability and/or a position of said one of the two or more loudspeakers.

In the following, particular embodiments of the present invention are described.

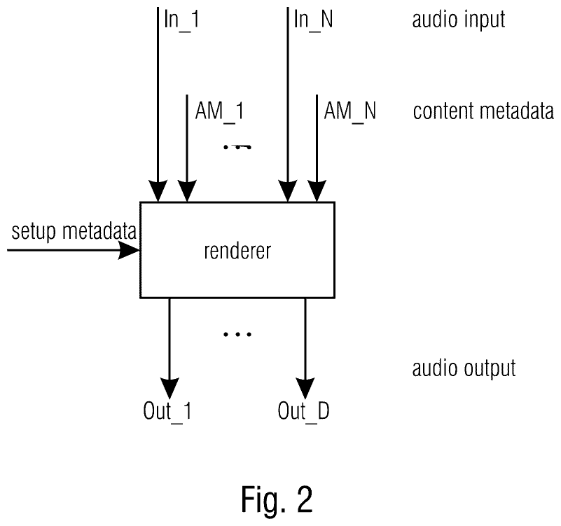

FIG. 2 illustrates an apparatus for rendering/a renderer according to an embodiment. The renderer is configured to receive at its input object audio data which comprises audio source signals with associated additional data/metadata. This additional data may, e.g., comprise an intended target position of an object for, e.g., N audio objects, but may, e.g., also comprise information describing the type of content or its intended usage.

Furthermore, the renderer may, e.g., be configured to receive setup metadata which may, e.g., comprise the positions of the loudspeakers in the current reproduction setup and may, e.g., comprise information such as the capabilities of individual loudspeakers in the reproduction setup. Setup metadata may, e.g., also comprise the defined listening position, or the actual position of a listener, if, for example, the listener position is tracked.

The renderer may, e.g., be configured to process every input signal and may, e.g., be configured to generate, as output, audio signals which, for example, can be directly used as loudspeaker feeds (i.e. one signal per LS) for the attached loudspeakers or devices.

And/or, as output, the renderer may, e.g., be configured to generate gain weighted input signals comprising the original input signals with relative weight per object per loudspeaker applied, e.g., already including the integration of the multiple instances (output=weighted object signals of all individual objects).

And/or, as output, the renderer may, e.g., be configured to generate the gain coefficients that shall be applied to the input signals for the respective loudspeaker. For example, in some embodiments, instead of modified audio signals (e.g., only) weights/metadata for input signal manipulation may, e.g., be generated.

According some embodiments, only one of the above-described outputs, exactly two of the above-described outputs, or all three of the above-described outputs is provided.

According to some embodiments, all of the above three possible outputs may, for example, be provided as combined output of a multi-instance rendering, or may, for example, be provided as a separate output per rendering instance.

In the following, panning concepts according to some particular embodiments are described.

According to some embodiments, a renderer may, e.g., define a function, for example, referred to as “basis function” or as “kernel”, for each loudspeaker. A renderer according to such embodiments may, e.g., be referred to as kernel renderer.

Such a basis function for loudspeaker i, may, for example, be denoted by:

$${g}_{i} = f ( p , {p}_{i} ) ,$$

where f is the (basis) function, p the target object position vector, and pᵢ the loudspeaker position vector. Function f computes the gain gᵢ for loudspeaker i when rendering an object at target position p is conducted.

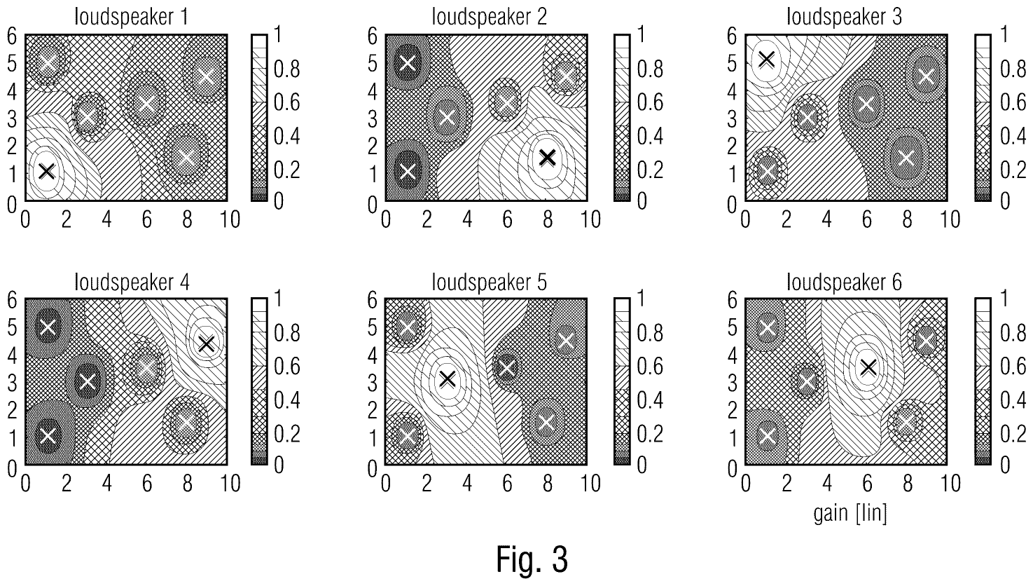

FIG. 3 illustrates the rendering gains of a basis function, wherein the axes indicate an object position, e.g., a target object position, (in FIG. 3, in a two-dimensional coordinate system) for a sound system with six randomly positioned loudspeakers according to an embodiment. The position of each of the six randomly positioned loudspeakers is depicted by a cross. For example, the abscissa axis and the ordinate axis may, e.g., define a position in meters. In other embodiments, the positions may, e.g., be defined in a three-dimensional coordinate system. In further embodiments, the positions may, e.g., be defined in a one-dimensional coordinate system, e.g., all loudspeaker positions and (target) object positions are located on a (one-dimensional) line. In other embodiments, all positions may, e.g., be defined in a spherical coordinate system/angular coordinate system (for example, defined using angular and elevation angles and, e.g., possibly, additionally using a distance value), or in a spherical coordinate system.

According to some embodiments, no discontinuities arise when listener position is moving, and full distance rendering may, e.g., be provided

In some embodiments, an object signal energy may, e.g., be rendered mostly to the loudspeaker nearest to target object position.

According to some embodiments, the basis function and thus the rendering may, e.g., be independent of listener position, and no special action may, e.g., be needed when listener position is changing.

In the following, further particular embodiments are provided.

A way to define the basis function is, for example, with a rule according to which each loudspeaker's gain shall be proportional to 1/r, where r is the distance of the target object position to the loudspeaker position. In this case, the loudspeaker basis function for a loudspeaker i of one or more loudspeakers may, e.g., be defined as follows:

$${g}_{i} = \frac{q}{{r}_{i}} , \qquad ( 1 )$$

where i is a loudspeaker index, rᵢ is the distance of a target object position to loudspeaker i, and q is a normalization factor, e.g., defined depending on the distance of the target object positions to the other loudspeakers. q may, for example, be defined as follows:

$$q = \frac{1}{\sqrt{{\sum }_{i} \frac{1}{{r}_{i}^{2}}}} , \qquad ( 2 )$$

According to some embodiments, the basis functions may, e.g., be adapted to a specific loudspeaker setup, for example, depending on actual loudspeaker setup geometry, and/or depending on specifics and/or technical limitations of individual loudspeaker, etc. Or, according to some embodiments, the basis functions may, e.g., be adapted to a specific type of audio input signal, for example, may, e.g., specifically be adapted for direct signals, ambience signals, speech signals, low frequency signals, high frequency signals, etc.

In the following index k indicating the one or more audio objects is omitted for simplicity: Some embodiments provide an improved version of a basis functions as:

$${g}_{i} = \frac{q {10}^{\frac{20}{}}}{{r}_{i}^{{α}_{i}}} , \qquad ( 3 )$$

where \tilde{G}ᵢ is a loudspeaker emphasis parameter indicating a loudspeaker emphasis/deemphasis in dB and αᵢ a distance attenuation parameter. Both parameters can be chosen individually per loudspeaker.

In some embodiments, [symbol] may, e.g., be set to 0 and

$${10}^{( \frac{{\tilde{G}}_{i}}{10} )} , or {s}^{( \frac{{\tilde{G}}_{i}}{t} )} , or {s}^{( \frac{{\tilde{G}}_{ik}}{t} )}$$

may, e.g., thus be deleted from equation (3).

In other embodiments, [symbol] may, e.g., be set to different values for at least two different loudspeakers.

Instead of using 10 as base in the exponential function

$${10}^{\frac{{\tilde{G}}_{i}}{20}} ,$$

a different, e.g., positive number different from 1, in particular, greater than 1, may, e.g., be employed, such as 2, 2.5, 3, 5, 20 or any other number greater than 1, for example, any other number smaller than or equal to 100, may, e.g., be employed.

Instead of using 20 as denominator in

$$\frac{20}{} ,$$

a different number different from 0, in particular, a positive number, e.g., 0.5, 1, 1.5, 2, 5, 10, 40, 50, or any other number greater than 0, for example, any other number smaller than or equal to 100, may, e.g., be employed.

In an embodiment, q=1 and/or q may, e.g., be deleted from equation (3). In such an embodiment, no normalization is conducted.

Regarding the normalization factor q, in some embodiments, the normalization factor q may, e.g., have a value different from 1.

For example, normalization factor q for equation (3), may, e.g., be defined as

$$q = \frac{1}{\sqrt{{\sum }_{i} \frac{{10}^{\frac{{G}_{i}}{10}}}{{r}_{i}^{2 {α}_{i}}}}} , \qquad ( 4 )$$

In some embodiments, a more general version of equation (3) is employed, which is provided in equation (5):

$${g}_{ik} = \frac{{q}_{k} {G}_{ik}}{{( {r}_{ik} )}^{{α}_{ik}}} , \qquad ( 5 )$$

i is a first index indicating an i-th loudspeaker of the two or more loudspeakers,
k is a second index indicating a k-th audio object of the two or more audio objects,
rᵢₖ indicates a distance between the i-th loudspeaker and the k-th audio object,
αᵢₖ indicates the distance attenuation information for the k-th audio object for the i-th loudspeaker,
wherein Gᵢₖ indicates the loudspeaker emphasis information for the k-th audio object for the i-th loudspeaker,
wherein qₖ indicates a normalization factor

According to an embodiment, a more a more general version of equation (4) is employed, which is provided in equation (6):

$${q}_{k} = \frac{1}{\sqrt{{\sum }_{i} \frac{{G}_{ik}^{2}}{{( {r}_{ik} )}^{2 {α}_{ik}}}}} , \qquad ( 6 )$$

There are many different strategies employed by different embodiments for setting the parameters αᵢ and Gᵢ. The distance attenuation parameter/factor αᵢ may, e.g., be set to the same value for all loudspeakers.

Small values of αᵢ result in more crosstalk between the loudspeakers and slower transitions than large values.

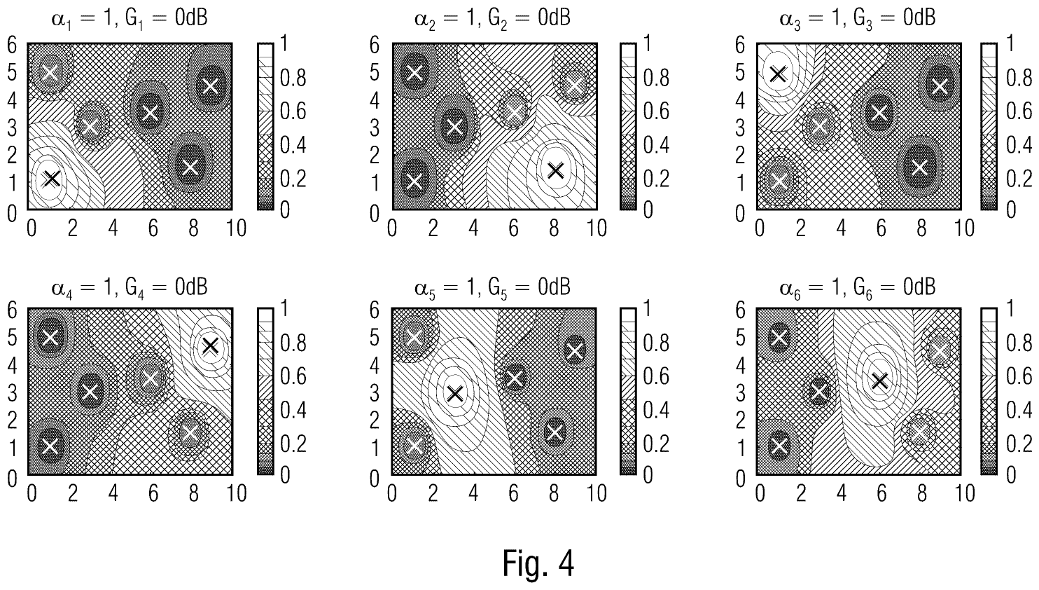

FIG. 4 illustrates the rendering gains of a basis function with respect to (target) object positions for a sound system with six randomly positioned loudspeakers according to an embodiment, wherein αᵢ is set to αᵢ=1.

It is noted that in FIG. 4-FIG. 13 the examples are likewise examples for αᵢₖ. For example, in the examples of FIG. 4-FIG. 13 αᵢₖ may, e.g., be considered to be defined as αᵢₖ=αᵢ.

In an embodiment, αᵢ=1 may, e.g., be employed as a standard/default value for αᵢ.

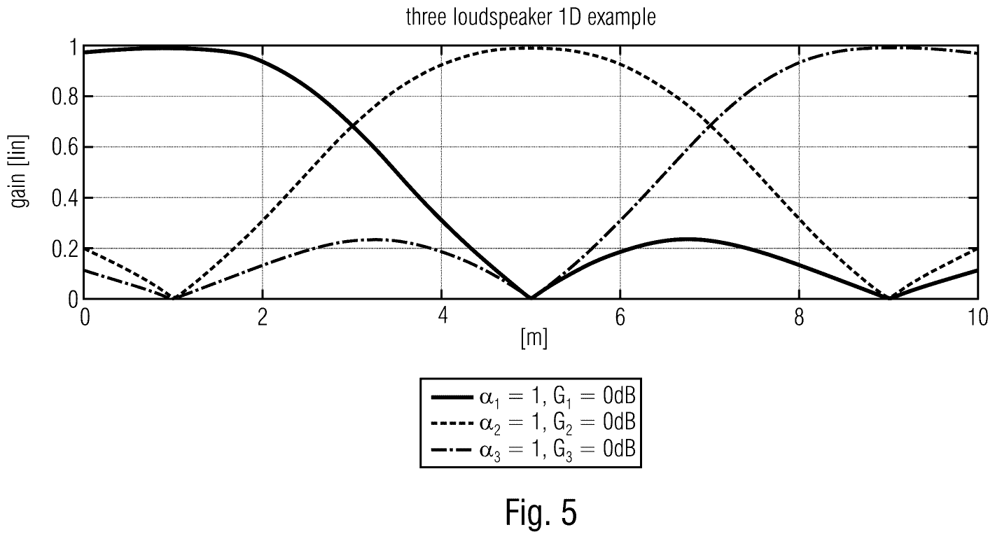

FIG. 5 illustrates the rendering gains of an example according to an embodiment, wherein three loudspeakers are positioned on a line (at 1 meter, 5 meter, and 9 meter) with αᵢ=1.

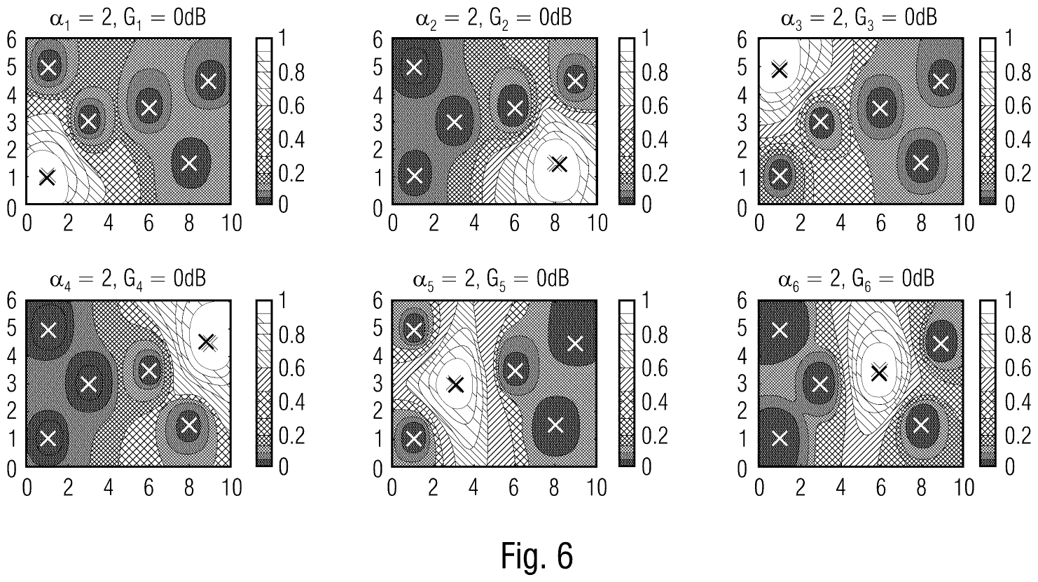

FIG. 6 illustrates the rendering gains of a basis function with respect to target object positions for a sound system with six randomly positioned loudspeakers according to a further embodiment, wherein αᵢ is set to αᵢ=2.

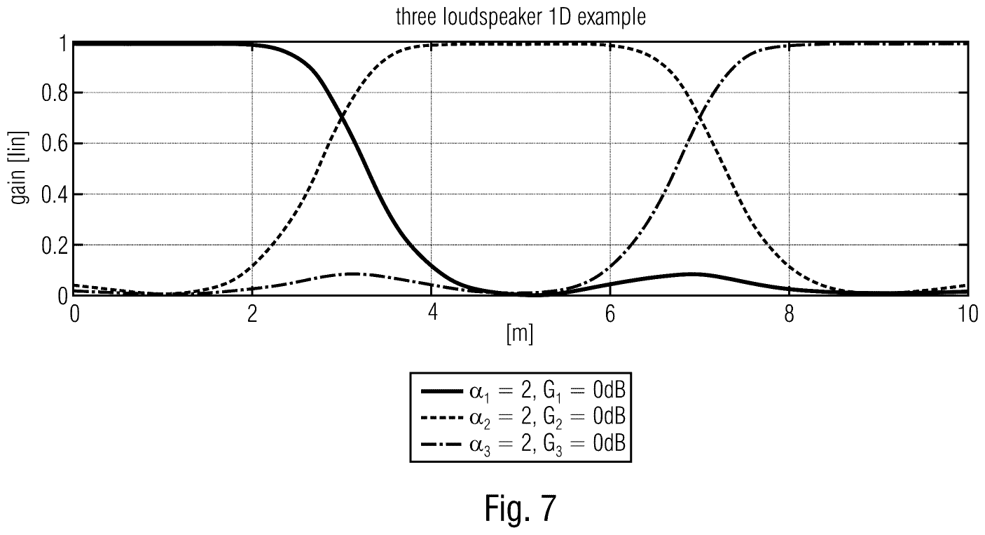

FIG. 7 illustrates the rendering gains of an example according to an embodiment, wherein three loudspeakers are positioned on a line with αᵢ=2.

Large values of αᵢ (here: αᵢ=2) result in faster transitions and less crosstalk compared to smaller values of αᵢ, such as αᵢ=1.

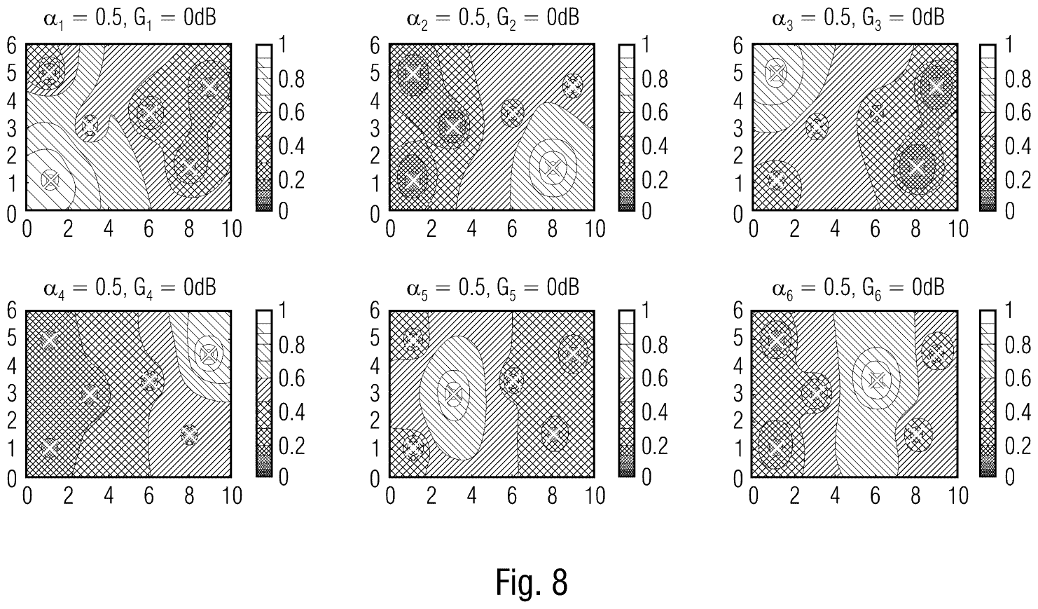

FIG. 8 illustrates the rendering gains of a basis function with respect to (target) object positions for a sound system with six randomly positioned loudspeakers according to another embodiment, wherein αᵢ is set to αᵢ=0.5.

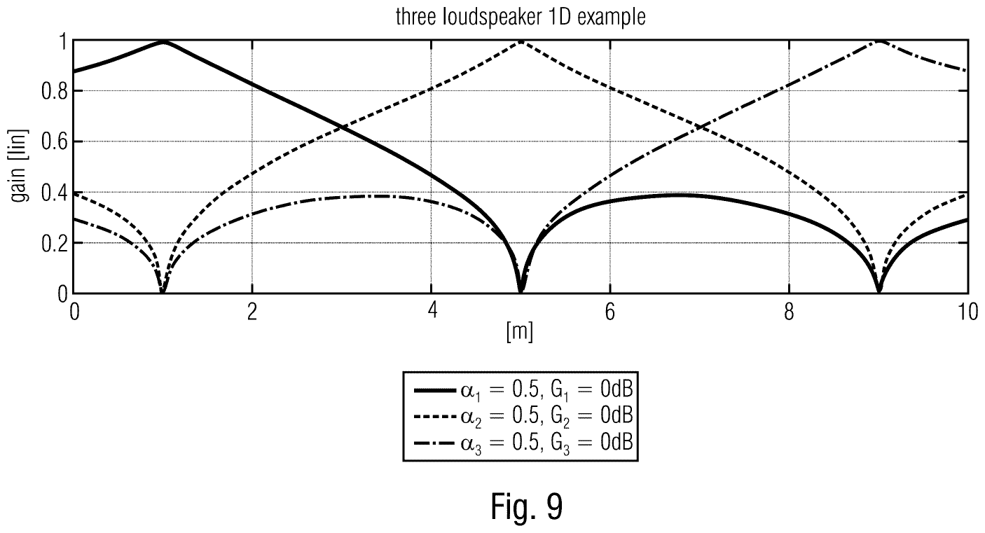

FIG. 9 illustrates the rendering gains of an example according to an embodiment, wherein three loudspeakers are positioned on a line with αᵢ=0.5 and Gᵢ=0 dB.

Small values of αᵢ=0.5 results in slower transitions and more crosstalk compared to larger values of αᵢ, such as αᵢ=1.

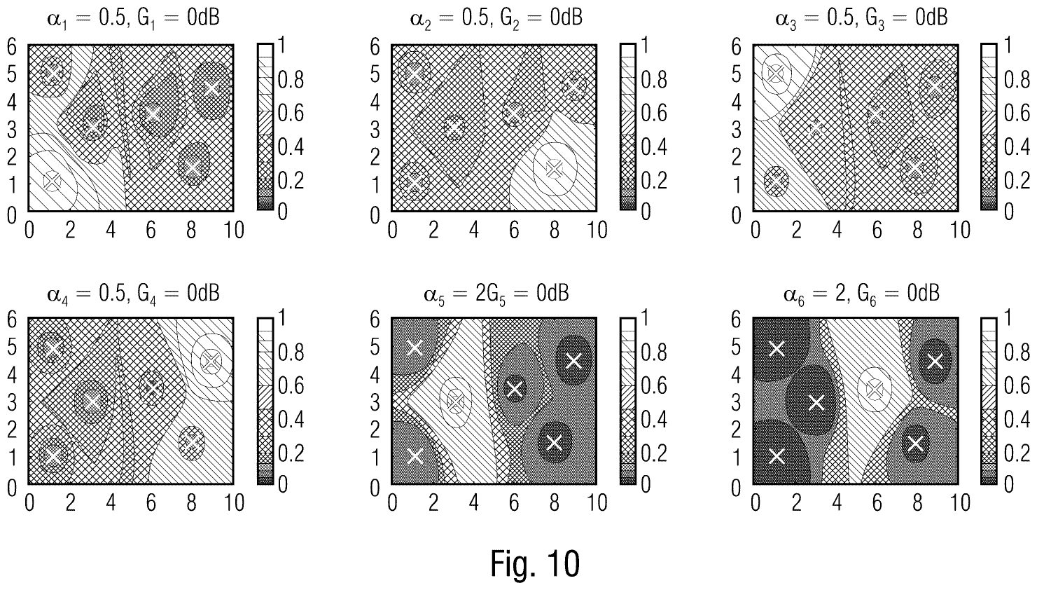

FIG. 10 illustrates the rendering gains of a basis function with respect to target object positions for a sound system with six randomly positioned loudspeakers according to another embodiment, wherein αᵢ is set to αᵢ=0.5 for i=1, 2, 3, 4, wherein αᵢ is set to αᵢ=2 for i=5, 6 and wherein Gᵢ=0 dB.

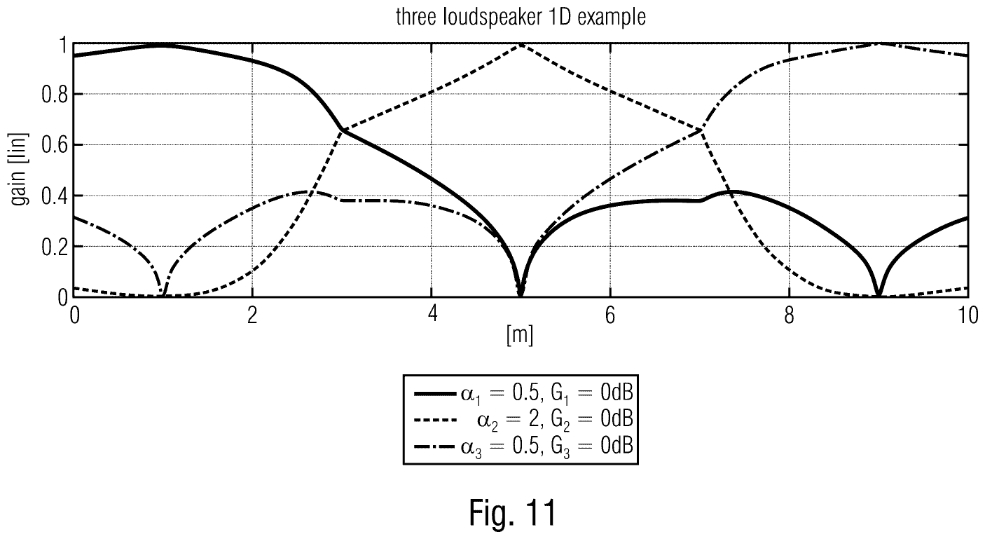

FIG. 11 illustrates the rendering gains of an example according to an embodiment, wherein three loudspeakers are positioned on a line with αᵢ=0.5 for i=1, 3; with αᵢ=2 for i=2; and with Gᵢ=0 dB.

Using, e.g., two different αᵢ for different loudspeakers, those loudspeakers with larger αᵢ reproduce less sound, when the audio object (source) is not proximate/close to the position of the respective loudspeaker.

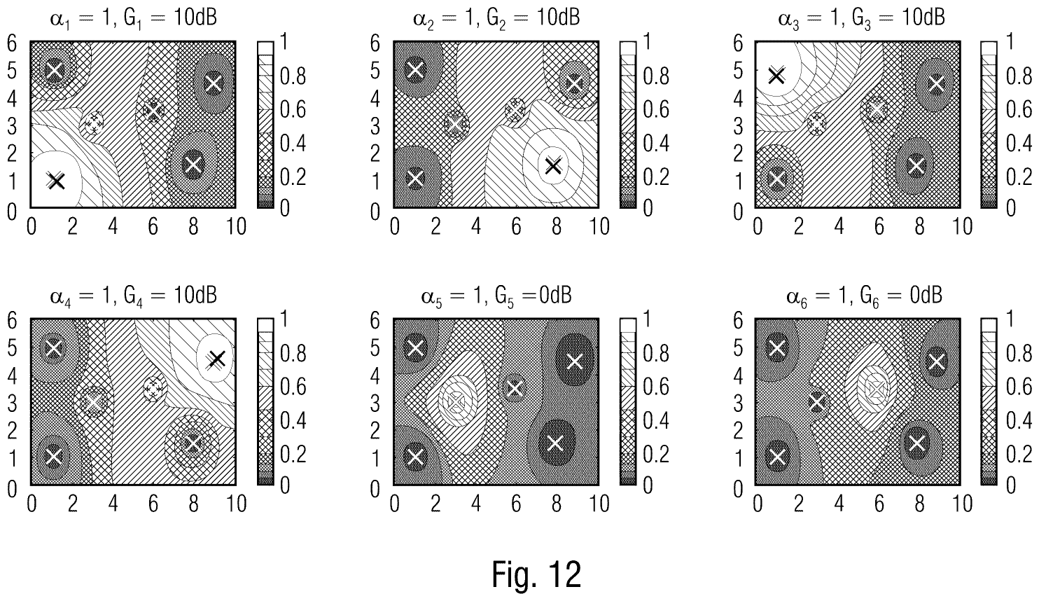

FIG. 12 illustrates the rendering gains of a basis function with respect to target object positions for a sound system with six randomly positioned loudspeakers according to a further embodiment, wherein αᵢ is set to αᵢ=1, wherein Gᵢ=10 dB for i=1, 2, 3, 4, and wherein Gᵢ=0 dB for i=5, 6.

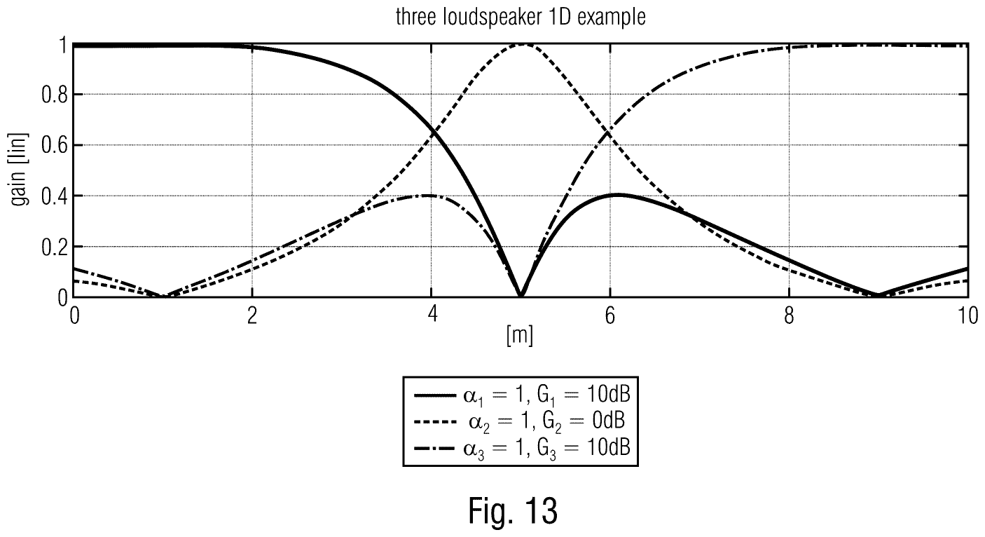

FIG. 13 illustrates the rendering gains of an example according to an embodiment, wherein three loudspeakers are positioned on a line wherein αᵢ=1; wherein Gᵢ=10 dB for i=1, 3; and wherein Gᵢ=0 dB for i=2.

When a loudspeaker emphasis parameter (loudspeaker emphasis/deemphasis gain) Gᵢ is large, e.g., 10 dB, then this loudspeaker will in general reproduce more sound than other loudspeakers with Gᵢ=0 dB. Only when the object position gets clearly closer to a loudspeaker with Gᵢ=0 dB, then such a loudspeaker reproduces a substantial amount of sound.

In general, when two or more different Gᵢ are employed for different loudspeakers, those loudspeakers with larger Gᵢ have a broader basis function, and the loudspeakers with smaller Gᵢ have a narrower basis function. Same distance to an audio object, in general, may, e.g., result in that more sound of the audio object is emitted by the loudspeaker with larger Gᵢ than from the loudspeaker with smaller Gᵢ.

For example, according to some embodiments, for rendering localized direct sound, values of 1 or larger may, e.g., be chosen for αᵢ. In some embodiments, for rendering of sound which should be more blurred, like ambience or reverb, smaller values for a; are used, such as 0.5 or even smaller. The sound is then more distributed in space with more crosstalk between the loudspeakers. In such an example for localized and blurred objects, different αᵢ are chosen for different objects.

For example, equation (3) or (5) may, e.g., be employed, and αᵢₖ may, e.g., be set for α₁ₖ≤1 for a direct sound audio object 1, and αᵢₖ may, e.g., be set for α₂ₖ≤0.5 for an ambient sound audio object 2.

In embodiments, the rendering may be fine-tuned or automatically be conducted, e.g., rule-based, for a specific loudspeaker setup by adjusting the αᵢ or αᵢₖ values for each loudspeaker individually, or even for each loudspeaker and for each object, for example, by employing equation (3) or (5). For example, known distances of the loudspeakers may, e.g., be employed. If one or more of these distances change, the parameter changes accordingly.

It can be seen in the plots that the parameter αᵢ or αᵢₖ has an influence on how distinct the individual loudspeakers are used to contribute to the reproduction of specific object target positions.

By this, it is possible to influence, if a signal shall be reproduced, e.g., in a more spread out way, for example, by allowing a larger spread of the signal energy over many loudspeakers, or, by allowing a smaller spread of the signal energy over the loudspeakers if a more distinct reproduction is preferred.

For moving sources, e.g. audio objects that dynamically move their position, this also has an influence on the rendering. While lower values of a result in larger transition areas. For example, for object positions in between several loudspeakers, more loudspeakers may, e.g., be used for the reproduction, and the distribution of signal energy to the loudspeaker changes smoothly. A higher value of αi or αᵢₖ basically results in sharper transition areas.

By this, in extreme settings, the signal energy may, e.g., “snap” only to the loudspeaker closest to the object until the object position reaches the vicinity of another loudspeaker position. In the small transition region between two proximate loudspeakers, the signal energy may, e.g., then be faded quickly from one loudspeaker to the other.

In embodiments, the αᵢ or αᵢₖ value may, e.g., be set to individual values for individual loudspeakers, and may, for example, be set to individual values for individual pairs of one of the loudspeakers and one of the audio objects.

According to some embodiments, the rendering may, e.g., be adapted depending on factors such as loudspeaker specifications, for example, their reproducible frequency range, their directivity, their directivity index, etc., or the system specifications such as the arrangement of the loudspeakers with respect to each other.

This mechanism may, e.g., be employed for loudspeakers with different capabilities with respect to a maximum sound pressure level or with respect to directivity.

For example, a device with a wide directivity may, e.g. be given a greater weight compared to a device with a small directivity. In in-house installations, such a gain factor may allow the combination of public address (PA) loudspeakers with ad-hoc small devices, such as satellite loudspeaker or portable devices.

In scenarios of embodiments, for example, in home reproduction scenarios, the Gᵢ parameter may, e.g., be employed when combining different devices such as a soundbar and a range of satellite loudspeakers, and/or when combining a good quality stereo setup with portable small devices.

Furthermore, in an embodiment, the αᵢ or αᵢₖ value may, e.g., be adapted to varying input signal types. According to some embodiments, such an adaptation may, for example, be handled separately for every input signal as part of a single rendering engine.

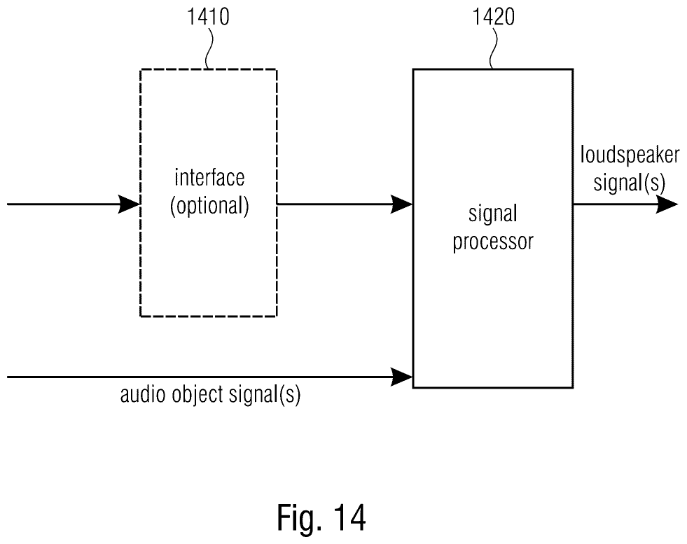

FIG. 14 illustrates an apparatus for rendering according to another embodiment.

The apparatus comprises a processing module 1420 configured to assign each loudspeaker of two or more loudspeakers of a loudspeaker setup to one or more loudspeaker subset groups of the two or more loudspeaker subset groups depending on one or more capabilities and/or a position of said loudspeaker, wherein at least one of the two or more loudspeakers is associated with fewer than all of the two or more loudspeaker subset groups.

The processing module 1420 is configured to associate each audio object signal of two or more audio object signals with at least one of two or more loudspeaker subset groups depending on a property of the audio object signal, such that at least one of the two or more audio object signals is associated with fewer than all of the two or more loudspeaker subset groups.

For each loudspeaker subset group of the two or more loudspeaker subset groups, the processing module 1420 is configured to generate for each loudspeaker of said loudspeaker subset group a loudspeaker component signal for each audio object of those of the two or more audio objects which are associated with said loudspeaker subset group depending on a position of said loudspeaker and depending on a position of said audio object.

Moreover, the processing module 1420 is configured to generate a loudspeaker signal for each loudspeaker of at least one of the two or more loudspeakers by combining all loudspeaker component signals of said loudspeaker of all loudspeaker subset groups to which said loudspeaker is assigned.

In an embodiment, one or more of the two or more loudspeakers may, e.g., be associated with at least two loudspeaker subset groups of the two or more loudspeaker subset groups.

According to an embodiment, one or more of the two or more loudspeakers may, e.g., be associated with every loudspeaker subset group of the two or more loudspeaker subset groups.

In an embodiment, the apparatus of FIG. 14 may, e.g., comprise an interface 1410 configured for receiving metadata information on the one or more capabilities and/or the position of at least one of the two or more loudspeakers.

According to an embodiment, the two or more loudspeakers comprise at least three loudspeakers.

In an embodiment, the processing module 1420 may, e.g., be configured to associate each audio object signal of two or more audio object signals with exactly one of the two or more loudspeaker subset groups.

According to an embodiment, the two or more audio object signals may, e.g., represent (e.g., result from) a signal decomposition of an audio signal into two or more frequency bands, wherein each of the two or more audio object signals relates to one of the two or more frequency bands. Each of the two or more audio object signals may, e.g., be associated with exactly one of the two or more loudspeaker subset groups.

In an embodiment, a cut-off frequency between a first one of the two or more frequency bands and a second one of the two or more frequency bands may, e.g., be smaller than 800 Hz.

According to an embodiment, the two or more audio object signals may, e.g., be three or more audio object signals representing a signal decomposition of an audio signal into three or more frequency bands. Each of the one or more audio object signals may, e.g., relate to one of the three or more frequency bands. Each of the three or more audio object signals may, e.g., be associated with exactly one of the two or more loudspeaker subset groups.

In an embodiment, a first cut-off frequency between a first one of the three or more frequency bands and a second one of the three or more frequency bands may, e.g., be smaller than a threshold frequency, and a second cut-off frequency between the second one of the three or more frequency bands and a third one of the three or more frequency bands may, e.g., be greater than or equal to the threshold frequency, wherein the threshold frequency may, e.g., be greater than or equal to 50 Hz and smaller than or equal to 800 Hz.

According to an embodiment, the apparatus may, e.g., be configured to receive said audio signal as an audio input signal. The processor 1420 may, e.g., be configured to decompose the audio input signal into the two or more audio object signals such that the two or more audio object signals represent the signal decomposition of the audio signal into two or more frequency bands.

According to an embodiment, the two or more audio object signals may, e.g., represent (e.g., result from) a signal decomposition of an audio signal into one or more direct signal components and one or more ambient signal components. Each of the two or more audio object signals may, e.g., be associated with exactly one of the two or more loudspeaker subset groups.

In an embodiment, the apparatus may, e.g., be configured to receive said audio signal as an audio input signal. The processor may, e.g., be configured to decompose the audio input signal into the two or more audio object signals such that the two or more audio object signals represent the signal decomposition of the audio signal into the one or more direct signal components and into the one or more ambient signal components. Moreover, the processor may, e.g., be configured to associate each of the two or more audio object signals with exactly one of the two or more loudspeaker subset groups.

According to an embodiment, the apparatus may, e.g., be configured to receive metadata indicating whether an audio object signal of the two or more audio object signals comprises the one or more direct signal components or whether said audio object signal comprises the one or more ambient signal components. And/or, the apparatus may, e.g., be configured to determine whether an audio object signal of the two or more audio object signals comprises the one or more direct signal components or whether said audio object signal comprises the one or more ambient signal components.

According to an embodiment, the two or more audio object signals may, e.g., represent (e.g., result from) a signal decomposition of an audio signal into one or more speech signal components and one or more background signal components. Each of the two or more audio object signals may, e.g., be associated with exactly one of the two or more loudspeaker subset groups.

In an embodiment, the apparatus may, e.g., be configured to receive said audio signal as an audio input signal. The processor may, e.g., be configured to decompose the audio input signal into the two or more audio object signals such that the two or more audio object signals represent the signal decomposition of the audio signal into the one or more speech signal components and into the one or more background signal components. The processor may, e.g., be configured to associate each of the two or more audio object signals with exactly one of the two or more loudspeaker subset groups.

According to an embodiment, the apparatus may, e.g., be configured to receive metadata indicating whether an audio object signal of the two or more audio object signals comprises the one or more speech signal components or whether said audio object signal comprises the one or more background signal components. And/or, the apparatus may, e.g., be configured to determine whether an audio object signal of the two or more audio object signals comprises the one or more speech signal components or whether said audio object signal comprises the one or more background signal components.

According to an embodiment, the apparatus may, e.g., be configured to receive information on that another loudspeaker being different from the two or more loudspeaker indicates its intention to reproducing audio content of the two or more object signals, and wherein, in response to said information, the apparatus may, e.g., be configured to assign said loudspeaker to one or more loudspeaker subset groups of the two or more loudspeaker subset groups depending on one or more capabilities and/or a position of said loudspeaker.

In an embodiment, the apparatus may, e.g., be configured to receive information on that one of the two or more loudspeakers is to stop or has stopped reproducing audio content of the two or more object signals, and wherein, in response to said information the processing module 1420 may, e.g., be configured to remove said loudspeaker from each of the two or more loudspeaker subset groups to which said loudspeaker has been assigned.

According to an embodiment, if said loudspeaker subset group comprises, without the loudspeaker that is to stop or that has stopped reproducing, exactly one loudspeaker of the two or more loudspeakers, the processing module 1420 may, e.g., be configured to reassign each of the two or more audio object signals which are associated with said loudspeaker subset group to said exactly one loudspeaker as an assigned signal of the one or more assigned signals of said exactly one loudspeaker. If said loudspeaker subset group comprises, without the loudspeaker that is to stop or that has stopped reproducing, at least two loudspeakers of the two or more loudspeakers, then, for each audio signal component of the two or more audio object signals, the processing module 1420 may, e.g., be configured to generate two or more signal portions from said audio object signal and is configured to assign each of the two or more signal portions to a different loudspeaker of said at least two loudspeakers as an assigned signal of the one or more assigned signals of said loudspeaker.

In an embodiment. the apparatus may, e.g., be configured to receive information on that the position of one of the two or more loudspeakers has changed, and wherein, in response to said information the processing module 1420 may, e.g., be configured to assign said loudspeaker to one or more loudspeaker subset groups of the two or more loudspeaker subset groups depending on the one or more capabilities and/or the position of said one of the two or more loudspeakers.

In an embodiment, the processing module 1420 may, e.g., be configured to generate a loudspeaker signal for each loudspeaker of at least one of the two or more loudspeakers by combining all loudspeaker component signals of said loudspeaker of all loudspeaker subset groups to which said loudspeaker is assigned.

According to an embodiment, the apparatus comprises one of the two or more loudspeakers.

In an embodiment, the apparatus comprises each of the two or more loudspeakers.

According to an embodiment, the processing module 1420 comprises the apparatus of FIG. 1. For each loudspeaker subset group of the two or more loudspeaker subset groups, the apparatus of FIG. 1 of the processing module 1420 may, e.g., be configured to generate, for each loudspeaker of said loudspeaker subset group a loudspeaker component signal for each audio object of those of the two or more audio objects which are associated with said loudspeaker subset group depending on a position of said loudspeaker and depending on a position of said audio object.

In an embodiment, the apparatus may, e.g., be configured to receive an audio channel signal. The apparatus may, e.g., be configured to generate an audio object from the audio channel signal by generating an audio object signal from the audio channel signal and by setting a position for the audio object.

According to an embodiment, the apparatus may, e.g., be configured to set a position for the audio object depending on a position or an assumed position or a predefined position of a loudspeaker that shall replay or is assumed to replay or is predefined to replay the audio channel signal.

In an embodiment, a loudspeaker arrangement comprises three or more loudspeakers. The apparatus may, e.g., be configured to only employ a proper subset of the three or more loudspeaker for reproducing the audio content of one or more audio objects.

According to an embodiment, when reproducing audio content of one or more audio objects, a position defined with respect to a listener moves, when the listener moves.

In an embodiment, when reproducing audio content of one or more audio objects, a position defined with respect to a listener does not move, when the listener moves.

Some embodiments may, e.g., be configured to initialize multiple instances of the renderer, for example, with potentially different parameter sets. Such a concept may, for example, be employed to circumvent technical limitations of the loudspeaker setup, for example, due to limited frequency ranges of individual loudspeakers.

In the following, specific implementation examples according to particular embodiments are described.

At first, multiband rendering is described.

For example, when employing linkable loudspeakers or smart speakers, by applying concepts of some embodiments, particular embodiments that employ multiband rendering realize to combine nearly any number of loudspeakers of different size as desired.

In the following, particular embodiments are provided that can render the audio input signals frequency selective.

According to particular embodiments, concepts are provided that achieve an advantageous (e.g., best possible) playback without discarding any content, even when used in loudspeaker setups that constitute a combination of large loudspeakers that can reproduce a wide frequency range, and smaller loudspeakers that can only reproduce a narrow frequency range.

In particular embodiments, in contrast to other systems, sound is rendered depending on the individual loudspeakers' capabilities, for example, depending on the frequency response of the different loudspeakers.

In contrast to approaches of the conventional technology, particular embodiments do not have to rely on the availability of a dedicated low frequency loudspeaker (e.g. a subwoofer).

Instead, according to particular embodiments, the loudspeakers capable of reproducing fullband signals may, e.g., be employed as fullband loudspeakers, and additionally, such loudspeakers may, e.g., be employed as low frequency reproduction means for other loudspeakers that are themselves not capable of reproducing low frequency signals.

Particular embodiments realize rendering a faithful, best possible fullrange spatial audio signal, even when some of the involved playback loudspeakers are not capable of playing back the full range of audio frequencies.

In some embodiments, metadata information, for example, setup metadata information about the capabilities of the loudspeakers involved in the actually present playback setup may be employed.

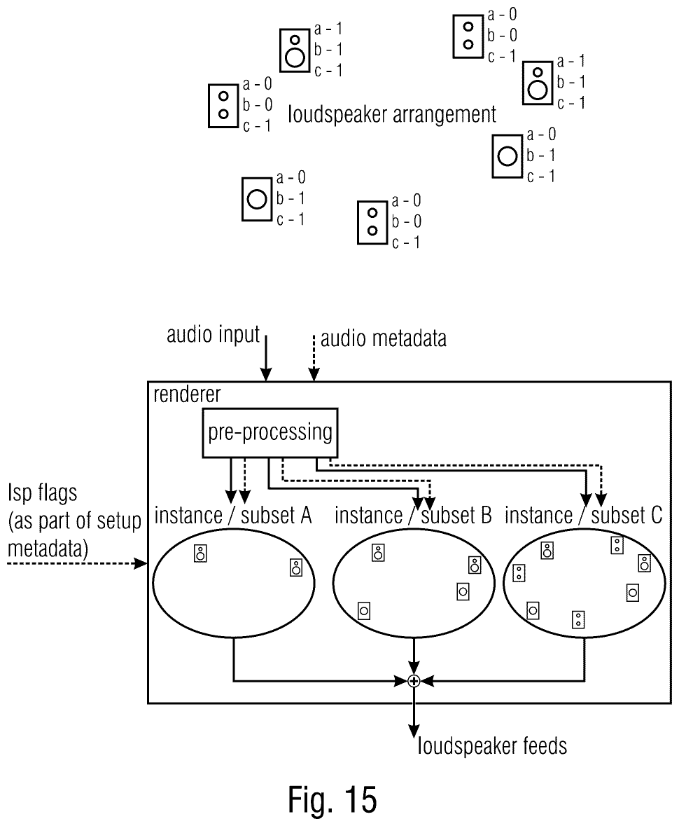

In the following, a particular loudspeaker arrangement and a multi-instance concept according to an embodiment is described with reference to FIG. 15. In particular, FIG. 15 depicts the loudspeaker setup as present in the listening environment.

In the example of FIG. 15, the loudspeaker arrangement comprises three different types of loudspeakers, wherein the three different types of loudspeakers are capable of playing back different frequency ranges. In some embodiments, such a capability may, e.g., be indicated by flags, for example, by loudspeaker flags, Isp flags.

In FIG. 15, a=1 indicates that a loudspeaker can play low frequencies, b=1 indicates that a loudspeaker can play mid frequencies, and c=1 indicates that a loudspeaker can play high frequencies.

In FIG. 15, three instances/subsets are depicted, namely, instance/subset A, instance/subset B, and instance/subset C. Each of the three subsets/instances comprises a subset of the loudspeakers of the loudspeaker arrangement. The loudspeakers may, e.g., be assigned to the different subsets/instances depending on their capabilities, for example, depending on the capability of a loudspeaker to replay low frequencies, and/or depending on the capability of a loudspeaker to replay mid frequencies, and/or depending on the capability of a loudspeaker to replay high frequencies.

It is noted that a different number of instances other than three instances may, for example, alternatively be employed, such as, 2 or 4 or 5 or a different number of subsets/instances. The number of subsets/instances may, for example, depend on the use case.

In an embodiment, the renderer may then, for example, be configured to reproduce each frequency band (e.g., of a plurality of frequency bands of a spectrum) depending on the subsets/instances, in FIG. 15, depending on subset A, subset B, subset C.

For example, in the embodiment of FIG. 15, a pre-processing unit of the renderer may, e.g., be employed comprising, for example, a set of filters that split the audio signal into different frequency bands, e.g., to obtain a plurality of audio portion signals, wherein each of the plurality of audio portion signals may, e.g., relate to a different frequency band, and may, for example, generate an individual loudspeaker feed from the plurality of audio portion signals for the loudspeakers of each instance/subset depending on the capabilities of the loudspeakers of said subset. The individual loudspeaker feed or each of the plurality of subsets is then fed into the loudspeakers of said subset.

In the following, direct/ambience rendering according a particular embodiment is described.

If the audio input objects are labeled as direct and ambient components, according to an embodiment, e.g., different instances/subsets and/or, e.g., different parameter sets may, e.g., be defined for the direct and ambient components.

Likewise, in an embodiment, a pre-processing unit may, e.g., comprise a direct-ambience-decomposition unit/may, e.g., conduct direct-ambience decomposition, and different instances/subsets and/or, e.g., different parameter sets may, e.g., then be defined for the direct and ambient components.

In an embodiment, the subsets may, e.g., be selected depending on a spatial arrangement of the loudspeakers. For example, while for direct sound, every loudspeaker may, e.g., be employed/taken into account, for ambient sound, only a subset of spatially equally distributed loudspeakers may, e.g., be employed/taken into account.

In an embodiment, parameter αᵢ or αᵢₖ and parameter Gᵢ may, e.g., be employed, and may, e.g., be selected according to one of the above-described embodiments. The parameter settings to ensure that for each content type an advantageous (e.g., best possible) reproduction is achieved. For example, a parameter setting may, e.g., be selected for replaying the audio objects relating to the ambience components such that ambience is perceived as wide as possible.

Regarding speech rendering, according to a particular embodiment, to ensure good speech intelligibility, the parameter settings may, e.g., be chosen, such that speech signals stay longer at a specific loudspeaker (“snap to speaker”) to avoid blurring due to rendering over multiple loudspeakers. By this, a tradeoff between spatial accuracy and speech intelligibility can be made.

The setting of those parameters may, e.g., be conducted during product design, or may, e.g., be offered as a parameter to the customer/user of the final product. The setting may also be defined based on rules that take the actual setup geometry and properties/capabilities of the different loudspeakers into account.

The same applies for the other embodiments described above, where a setting of the parameters may, e.g., likewise be conducted during product design, or may, e.g., likewise be offered as a parameter to the customer/user of the final product.

In the following, processing of channels and objects according to particular embodiments is described. The following explanations and embodiments are similarly or analogously applicable for direct-ambience rendering.

For channel-based input, pre-Processing may, e.g. comprise a step of generating metadata for the channel-based input content. Such channel-based input may, for example, be legacy channel content that has no associated metadata.

In the following, concepts according to some embodiments for processing legacy input that does not comprise object audio metadata are provided.

If legacy content without metadata is used as input, e.g., for an audio processor, or, e.g., for an audio renderer, audio content metadata may, e.g., be produced in a pre-processing step. Such legacy content may, e.g., be channel-based content.

According to an embodiment, the generation of metadata for channel-based and/or legacy content may, for example, be conducted depending on information about the loudspeaker setups that the channel based content was produced for.

Accordingly, if the input is e.g. two-channel content, the angles of a standard two-channel stereophonic reproduction setup (±30 degree for the left and right channel) may, e.g., be used. Another example would be the angles for 5.1 channel-based input, for example, channel-based input, which may, e.g., be defined according to ITU Recommendation BS.775, which are ±30 degree for the left and right front channel, 0 degree for the center front channel, and +110 degree for the left and right surround channel.

In another embodiment, the angles and distances for the generation of metadata for legacy content may, for example, be freely chosen, for example, freely chosen during system implementation, e.g., to achieve specific rendering effects.

Examples above that relate to horizontal angles and/or two-dimensions, are likewise applicable for vertical angles and/or three-dimensions. In an embodiment, positional object metadata may, for example, comprise azimuth and elevation information.

In the examples given above, the elevation information may e.g. be interpreted as 0 degree, since commonly, the loudspeakers in standardized “horizontal only” setups may, e.g., be assumed to be at ear height.

In some embodiments, enhanced reproduction setups for realistic sound reproduction may, e.g., be employed, which may, e.g., use loudspeakers not only mounted in the horizontal plane, usually at or close to ear-height of the listener, but additionally also loudspeakers spread in vertical direction. Those loudspeakers may, e.g., be elevated, for example, mounted on the ceiling, or at some angle above head height, or may, e.g., be placed below the listener's ear height, for example, on the floor, or on some intermediate or specific angle.

In the case of generating metadata for legacy audio input, distance information may, e.g., be employed in addition to the angle positional information. According to some embodiments, generating distance information may, e.g., be conducted, if the positional information of object audio input does not have specific distance information.

For example, in an embodiment, the distance information may, e.g., be generated by setting the distance, e.g., to a standard distance (for example, 2 m).

Or, in another embodiment, the distance information may, e.g., be selected and/or generated, e.g., depending on the actual setup. That the distance generation is conducted depending on the actual setup is beneficial, since it may, e.g., influence, how the renderer distributes signal energy to the different available loudspeakers.

According to some embodiments, such adaptation may, e.g., be conducted using a dimensionless approach (e.g., using a unit circle).

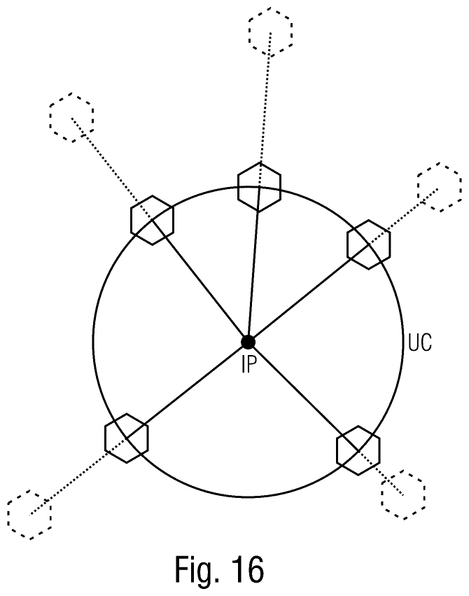

FIG. 16 indicates a loudspeaker setup comprising loudspeakers wherein true loudspeaker positions are mapped onto a unit circle around a listening position according to an embodiment.

In particular, in FIG. 16, LP indicates a listening position or sweet spot. The dashed hexagons represent the true loudspeaker positions, with distances to the sweet spot indicated as dashed lines. UC indicates a unit circle. The solid hexagons indicate normalized loudspeaker distances.

FIG. 16 indicates that the metadata comprises the loudspeaker positions that are manipulated from their real positions onto positions on a unit circle.

In some embodiments, the system in the listening environment may, e.g., be calibrated, such that gain and delay of the loudspeakers are adjusted to virtually move the loudspeakers to the unit circle. The gain and delay of the signals fed to the loudspeakers may, e.g., be adjusted, such that they correspond to signals that would be played by the normalized loudspeakers on the unit circle.

In this scenario of legacy content reproduction, the reproduction of the audio content may, e.g., not be conducted depending on different distances, but the parameter αᵢ or αᵢₖ and parameter Gᵢ may, e.g., in some embodiments, be employed to influence the transitions between different loudspeakers and to influence the rendering if e.g. different loudspeakers are used.

Other embodiments relate to three dimensions, and a similar or analogous procedure may, e.g., be conducted on a unit-sphere.

According to other embodiments, other context sensitive metadata manipulation may, e.g., also be conducted. For example, in an embodiment, the sound field may, e.g., be turned/re-oriented.

In the following, distance rendering and a consideration of a listener position according to particular embodiments is described in detail.

In some embodiments, azimuth, elevation and distance values may, e.g., be employed to describe positional information in the metadata. However, the renderer may, e.g., also work with Cartesian coordinates, which enable, e.g., compatibility with virtual or computer generated environments. The renderer may, e.g., be beneficially used, for example, in interactive Virtual Reality (VR) or Augmented Reality (AR) use cases.

In some embodiments, the coordinates may, e.g., be indicated relative to a position.

According to some embodiments, the coordinates may, e.g., be indicated as absolute positions in a given coordinate system.

In some embodiments, the described rendering concepts may, e.g., be employed in combination with a concept to track the actual listener position and adapt the rendering in real-time depending on the position of one or more listeners. This allows to use the panning concepts also in a multi-setup or in a multi-room loudspeaker arrangement, where the listener may, e.g., move between different setups or different rooms, and where the sound is intended to follow the listener.

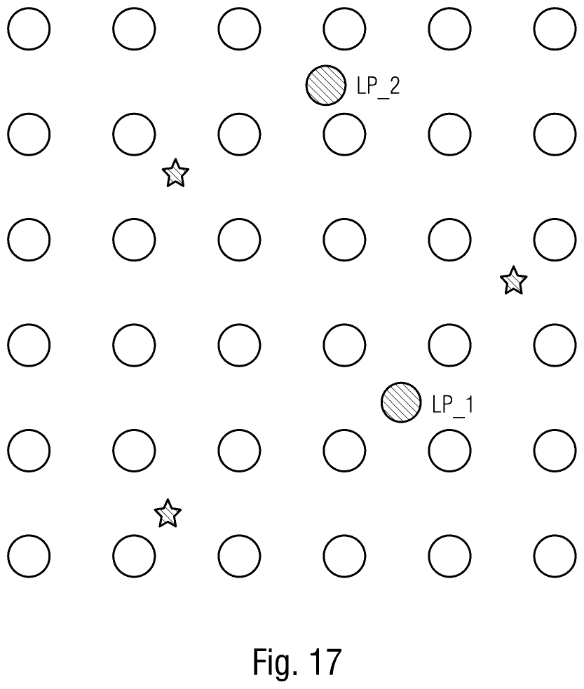

FIG. 17 illustrates, how concepts according to an embodiment may, e.g., be employed to conduct distance rendering in arbitrary loudspeaker setups. In particular, FIG. 17 displays 36 loudspeakers in a regular grid for illustration purposes, but the setup could also be random.

In FIG. 17, a first listening position LP_1 and a second listening position LP_2 are depicted. Three audio objects are positioned.

There positions are described with respect to an absolute coordinate description. That means, that the rendered audio objects will keep their absolute position, if e.g. a listener moves from LP_1 to LP_2. Likewise, if two listeners are present, one at LP_1, one at LP_2, both will perceive the rendered audio objects from the same absolute position within the room.

According to the embodiment of FIG. 17, it is e.g. possible to scale a complete audio scene and to adapt the audio scene to an actually present loudspeaker setup or playback scenario. For example, if the playback room is known and equipped with several loudspeakers, the audio scene/the distance metadata for the individual one or more objects may, e.g., be scaled such that it fills/uses the complete available room.

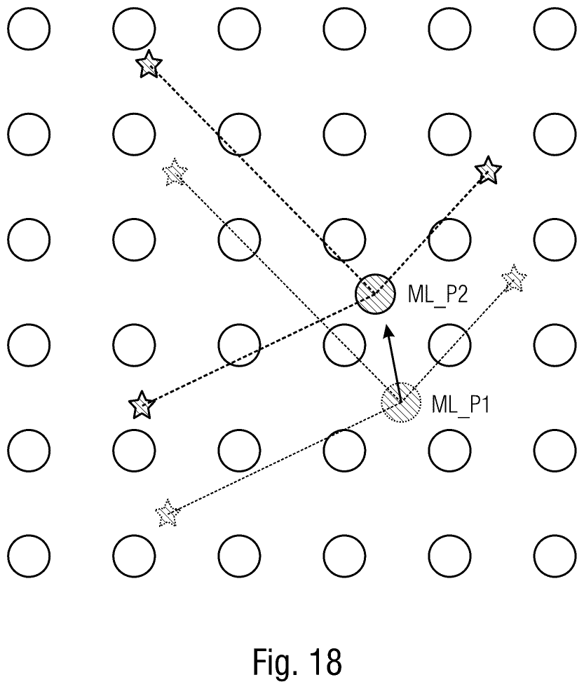

FIG. 18 illustrates an example for a rendering approach according to an embodiment, when the actual listener position is tracked. In the approach depicted by FIG. 18, the audio objects stay at the same relative azimuth, elevation, and distance with respect to the listener. For the listener, the rendered audio objects keep the same relative position, if the listener moves from ML_P1 to ML_P2.

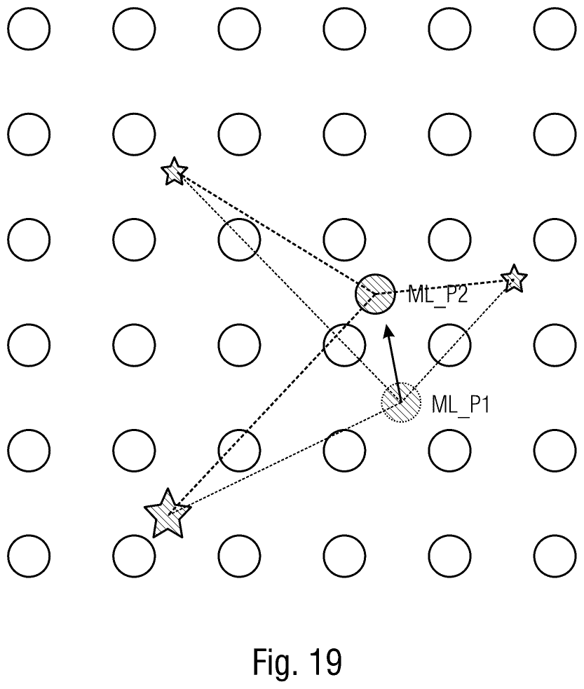

FIG. 19 illustrates an example for a rendering approach according to another embodiment, when the actual listener position is tracked. In the approach depicted by FIG. 19 a tracked listener position may, e.g., keep the absolute positions of the rendered objects, but adjust the loudspeaker signals by adjusting the gain and delay according to the listener position. This is indicated by scaled objects. In the scenario of FIG. 19, the level-balance between all objects may, e.g., be kept the same, and their positions stay the same. This means, if a listener is moving toward an object position, this object would be attenuated to keep the perceived loudness the same.

All the above explanations are likewise applicable for a tracked rotation of a listener.

New panning concepts according to the above-described embodiments have been provided.

Moreover, concepts have been provided, how, according to some embodiments, different signal types may, e.g., be employed for signal-type specific or device-type specific panning.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An apparatus for rendering, wherein the apparatus is configured to generate an audio output signal for a loudspeaker of a loudspeaker setup from one or more audio objects, wherein each of the one or more audio objects comprises an audio object signal and exhibits a position, wherein the apparatus comprises:
an interface configured to receive information on the position of each of the one or more audio objects,
a gain determiner configured to determine gain information for each audio object of the one or more audio objects for the loudspeaker depending on a distance between the position of said audio object and a position of the loudspeaker and depending on distance attenuation information and/or loudspeaker emphasis information, and
a signal processor configured to generate an audio output signal for the loudspeaker depending on the audio object signal of each of the one or more audio objects and depending on the gain information for each of the one or more audio objects for the loudspeaker.

2. An apparatus according to claim 1,
wherein the gain determiner is configured to determine the gain information for each audio object of the one or more audio objects depending on the distance attenuation information.

3. An apparatus according to claim 2,
wherein the interface is configured to receive metadata information, and
wherein the gain determiner is configured to determine the distance attenuation information from the metadata information.

4. An apparatus according to claim 2,
wherein, when the distance attenuation information indicates that a distance between the position of an audio object of the one or more audio objects and the position of the loudspeaker shall have a greater influence on an attenuation of said audio object in the audio output signal, the gain determiner is configured to attenuate the audio object signal of said audio object more or to amplify the audio object signal of said audio object less for generating the audio output signal, compared to when the distance attenuation information indicates that distance between the position of said audio object and the position of the loudspeaker shall have a smaller influence on the attenuation of said audio object in the audio output signal.

5. An apparatus according to claim 2,
wherein the apparatus is configured to generate the audio output signal for the loudspeaker from the one or more audio objects being two or more audio objects,
wherein the interface is configured to receive information on the position of each of two or more audio objects,
wherein the gain determiner is configured to determine gain information for each audio object of the two or more audio objects for the loudspeaker depending on a distance between the position of said audio object and the position of the loudspeaker and depending on the distance attenuation information, and
wherein the signal processor is configured to generate the audio output signal for the loudspeaker depending on the audio output signal of each of the two or more audio objects and depending on the gain information for each of the two or more audio objects for the loudspeaker.

6. An apparatus according to claim 5,
wherein the distance attenuation information indicates, for each audio object of the two or more audio objects, a same influence of a distance between a position of the loudspeaker and a position of said audio object on the determining of the gain information.

7. An apparatus according to claim 6,
wherein the distance attenuation information comprises a single distance attenuation parameter indicating the distance attenuation information for all of the two or more audio objects.

8. An apparatus according to claim 5,
wherein the distance attenuation information indicates, for at least two audio objects of the two or more audio objects, that an influence of a distance between a position of the loudspeaker and a position of one of the at least two audio objects on the determining of the gain information is different for the at least two audio objects.

9. An apparatus according to claim 8,
wherein the distance attenuation information comprises at least two different distance attenuation parameters, wherein the at least two different distance attenuation parameters indicate different distance attenuation information for the at least two audio objects.

10. An apparatus according to claim 8,
wherein the interface is configured to receive metadata indicating whether an audio object of the two or more audio objects is a speech audio object or whether said audio object is a non-speech audio object, and wherein the gain determiner is configured to determine the distance attenuation information depending on whether said audio object is a speech audio object or whether said audio object is a non-speech audio object; and/or
wherein the apparatus is configured to determine whether an audio object of the two or more audio objects is a speech audio object or whether said audio object is a non-speech audio object depending on the audio object signal of said audio object, and wherein the gain determiner is configured to determine the distance attenuation information depending on whether said audio object is a speech audio object or whether said audio object is a non-speech audio object.

11. An apparatus according to claim 8,
wherein the interface is configured to receive metadata indicating whether an audio object of the two or more audio objects is a direct signal audio object or whether said audio object is an ambient signal audio object, and wherein the gain determiner is configured to determine the distance attenuation information depending on whether said audio object is a direct signal audio object or whether said audio object is an ambient audio object; and/or
wherein the apparatus is configured to determine whether an audio object of the two or more audio objects is a direct signal audio object or whether said audio object is an ambient signal audio object depending on the audio object signal of said audio object, and wherein the gain determiner is configured to determine the distance attenuation information depending on whether said audio object is a direct signal audio object or whether said audio object is an ambient signal audio object.

12. An apparatus according to claim 2,
wherein the loudspeaker is a first loudspeaker,
wherein the loudspeaker setup comprises the first loudspeaker and one or more further loudspeakers as two or more loudspeakers,
wherein the distance attenuation information comprises distance attenuation information for the first loudspeaker,
wherein the interface is configured to receive an indication on a capability and/or a position of each of the one or more further loudspeakers,
wherein the gain determiner is configured to determine the distance attenuation information for the first loudspeaker depending on a capability and/or a position of the first loudspeaker and depending on the indication on the capability and/or the position of each of the one or more further loudspeakers, and
wherein the gain determiner is configured to determine the gain information depending on the distance attenuation information for the first loudspeaker.

13. An apparatus according to claim 12,
wherein the gain determiner is configured to determine the distance attenuation information for the first loudspeaker depending on a signal property of an audio object signal of at least one of the one or more audio objects, and/or depending on a position of at least one of the one or more audio objects.

14. An apparatus according to claim 12,
wherein the distance attenuation information comprises distance attenuation information for each of the one or more further loudspeakers,
wherein the gain determiner is configured to determine the distance attenuation information for each of the one or more further loudspeakers depending on the capability and/or the position of the first loudspeaker and depending on the indication on the capability and/or the position of each of the one or more further loudspeakers,
wherein the gain determiner is configured to determine the gain information depending on the distance attenuation information for each of the one or more further loudspeakers.

15. An apparatus according to claim 14,
wherein the gain determiner is configured to determine the distance attenuation information for each of the one or more further loudspeakers depending on a signal property of an audio object signal of at least one of the one or more audio objects, and/or depending on a position of at least one of the one or more audio objects.

16. An apparatus according to claim 1,
wherein the gain determiner is configured to determine the gain information for each audio object of the one or more audio objects depending on the loudspeaker emphasis information.

17. An apparatus according to claim 16,
wherein the interface is configured to receive metadata information, and
wherein the gain determiner is configured to determine the loudspeaker emphasis information from the metadata information.

18. An apparatus according to claim 16,
wherein, when the loudspeaker emphasis information for the loudspeaker indicates that that the loudspeaker shall be amplified less or attenuated more, the gain determiner is configured to attenuate the audio object signal of the audio object more or to amplify the audio object signal of the audio object less for generating the audio output signal for the loudspeaker, compared to when the loudspeaker emphasis information for the loudspeaker indicates that the loudspeaker shall be attenuated less or amplified more.

19. An apparatus according to claim 16,
wherein the loudspeaker is a first loudspeaker, wherein the loudspeaker setup comprises the first loudspeaker and one or more further loudspeakers as two or more loudspeakers,
wherein the loudspeaker emphasis information comprises loudspeaker emphasis information for the first loudspeaker,
wherein the interface is configured to receive an indication on a capability and/or a position of each of the one or more further loudspeakers, and
wherein the gain determiner is configured to determine the loudspeaker emphasis information for the first loudspeaker depending on a capability and/or a position of the first loudspeaker and depending on the indication on the capability and/or the position of each of the one or more further loudspeakers,
wherein the gain determiner is configured to determine the gain information depending on the loudspeaker emphasis information for the first loudspeaker.

20. An apparatus according to claim 19,
wherein the gain determiner is configured to determine the loudspeaker emphasis information for the first loudspeaker depending on a signal property of an audio object signal of at least one of the one or more audio objects, and/or depending on a position of at least one of the one or more audio objects.

21. An apparatus according to claim 19,
wherein the loudspeaker emphasis information comprises loudspeaker emphasis information for each of the one or more further loudspeakers,
wherein the gain determiner is configured to determine the loudspeaker emphasis information for each of the one or more further loudspeakers depending on the capability and/or the position of the first loudspeaker and depending on the indication on the capability and/or the position of each of the one or more further loudspeakers,
wherein the gain determiner is configured to determine the gain information depending on the loudspeaker emphasis information for each of the one or more further loudspeakers.

22. An apparatus according to claim 21,
wherein the gain determiner is configured to determine the loudspeaker emphasis information for each of the one or more further loudspeakers depending on a signal property of an audio object signal of at least one of the one or more audio objects, and/or depending on a position of at least one of the one or more audio objects.

23. An apparatus according to claim 19,
wherein the signal processor is configured to generate an audio output signal for each of the two or more loudspeakers depending on the audio object signal of each of the one or more audio objects and depending on the gain information for each of the one or more audio objects for said loudspeaker.

24. An apparatus according to claim 19,
wherein the interface is adapted to receive loudspeaker emphasis information that indicates, for each loudspeaker of the two or more loudspeaker, same attenuation or amplification information for each of the two or more loudspeakers for the determining of the gain information.

25. An apparatus according to claim 24,
wherein the interface is adapted to receive the loudspeaker emphasis information comprising a single loudspeaker emphasis parameter indicating the attenuation or amplification information for each of the two or more loudspeakers.

26. An apparatus according to claim 19,
wherein the interface is adapted to receive loudspeaker emphasis information which indicates, for at least two audio objects of the two or more audio objects, that the attenuation or amplification information for the at least two loudspeakers for the determining of the gain information is different.

27. An apparatus according to claim 26,
wherein the interface is adapted to receive the loudspeaker emphasis information comprising at least two different loudspeaker emphasis parameters, wherein the at least two different loudspeaker emphasis parameters indicate different loudspeaker emphasis information for the at least two loudspeakers.

28. An apparatus according to claim 12,
wherein a first one of the at least two loudspeakers is a first type of loudspeaker, and
wherein a second one of the at least two loudspeakers is a second type of loudspeaker.

29. An apparatus according to claim 12,
wherein the gain determiner is configured to determine the gain information for each audio object of the one or more audio objects for the loudspeaker depending on the formula:
$${g}_{ik} = \frac{{q}_{k} {G}_{ik}}{{( {r}_{ik} )}^{{α}_{ik}}} ,$$
wherein i is a first index indicating an i-th loudspeaker of the two or more loudspeakers,
wherein k is a second index indicating a k-th audio object of the two or more audio objects,
wherein rᵢₖ indicates a distance between the i-th loudspeaker and the k-th audio object,
wherein αᵢₖ indicates the distance attenuation information for the k-th audio object for the i-th loudspeaker,
wherein Gᵢₖ indicates the loudspeaker emphasis information for the k-th audio object for the i-th loudspeaker,
wherein qₖ indicates a normalization factor.

30. An apparatus according to claim 29,
wherein q, is defined depending on:
$${q}_{k} = \frac{1}{\sqrt{{\sum }_{i} \frac{{G}_{ik}^{2}}{{( {r}_{ik} )}^{2 {α}_{ik}}}}} .$$

31. An apparatus according to claim 12,
wherein the apparatus is configured to receive information on that another loudspeaker being different from the two or more loudspeaker indicates its intention to reproducing audio content of the two or more object signals, and wherein, in response to said information, the gain determiner is configured to determine the distance attenuation information and/or the loudspeaker emphasis information depending on a capability and/or a position of said other loudspeaker.

32. An apparatus according to claim 12,
wherein the apparatus is configured to receive information on that one of the two or more loudspeakers is to stop or has stopped reproducing audio content of the two or more object signals, and wherein, in response to said information the gain determiner is configured to determine the distance attenuation information and/or the loudspeaker emphasis information depending on a capability and/or a position of each of one or more remaining loudspeakers of the two or more loudspeakers.

33. An apparatus according to claim 19,
wherein the apparatus is configured to receive information on that the position of one of the two or more loudspeakers has changed, and wherein, in response to said information the gain determiner is configured to determine the distance attenuation information and/or the loudspeaker emphasis information depending on a capability and/or a position of said one of the two or more loudspeakers.

34. An apparatus for rendering, wherein the apparatus comprises:
a processing module configured to assign each loudspeaker of the two or more loudspeakers to one or more loudspeaker subset groups of the two or more loudspeaker subset groups depending on one or more capabilities and/or a position of said loudspeaker, wherein at least one of the two or more loudspeakers is associated with fewer than all of the two or more loudspeaker subset groups,
wherein the processing module is configured to associate each audio object signal of two or more audio object signals with at least one of two or more loudspeaker subset groups depending on a property of the audio object signal, such that at least one of the two or more audio object signals is associated with fewer than all of the two or more loudspeaker subset groups,
wherein, for each loudspeaker subset group of the two or more loudspeaker subset groups, the processing module is configured to generate for each loudspeaker of said loudspeaker subset group a loudspeaker component signal for each audio object of those of the two or more audio objects which are associated with said loudspeaker subset group depending on a position of said loudspeaker and depending on a position of said audio object,
wherein the processing module is configured to generate a loudspeaker signal for each loudspeaker of at least one of the two or more loudspeakers by combining all loudspeaker component signals of said loudspeaker of all loudspeaker subset groups to which said loudspeaker is assigned.

35. An apparatus according to claim 34,
wherein one or more of the two or more loudspeakers is associated with at least two loudspeaker subset groups of the two or more loudspeaker subset groups.

36. An apparatus according to claim 34,
wherein one or more of the two or more loudspeakers is associated with every loudspeaker subset group of the two or more loudspeaker subset groups.

37. An apparatus according to claim 34,
wherein the apparatus comprises an interface configured for receiving metadata information on the one or more capabilities and/or the position of at least one of the two or more loudspeakers.

38. An apparatus according to claim 34,
wherein the two or more loudspeakers comprise at least three loudspeakers.

39. An apparatus according to claim 34,
wherein the processing module is configured to associate each audio object signal of two or more audio object signals with exactly one of the two or more loudspeaker subset groups.

40. An apparatus according to claim 34,
wherein the two or more audio object signals represent a signal decomposition of an audio signal into two or more frequency bands, wherein each of the two or more audio object signals relates to one of the two or more frequency bands,
wherein each of the two or more audio object signals is associated with exactly one of the two or more loudspeaker subset groups.

41. An apparatus according to claim 40,
wherein a cut-off frequency between a first one of the two or more frequency bands and a second one of the two or more frequency bands is smaller than 800 Hz.

42. An apparatus according to claim 40,
wherein the two or more audio object signals are three or more audio object signals representing a signal decomposition of an audio signal into three or more frequency bands, wherein each of the one or more audio object signals relates to one of the three or more frequency bands,
wherein each of the three or more audio object signals is associated with exactly one of the two or more loudspeaker subset groups.

43. An apparatus according to claim 42,
wherein a first cut-off frequency between a first one of the three or more frequency bands and a second one of the three or more frequency bands is smaller than a threshold frequency, and
wherein a second cut-off frequency between the second one of the three or more frequency bands and a third one of the three or more frequency bands is greater than or equal to the threshold frequency,
wherein the threshold frequency is greater than or equal to 50 Hz and smaller than or equal to 800 Hz.

44. An apparatus according to claim 40,
wherein the apparatus is configured to receive said audio signal as an audio input signal,
wherein the processor is configured to decompose the audio input signal into the two or more audio object signals such that the two or more audio object signals represent the signal decomposition of the audio signal into two or more frequency bands.

45. An apparatus according to claim 34,
wherein the two or more audio object signals represent a signal decomposition of an audio signal into one or more direct signal components and one or more ambient signal components,
wherein each of the two or more audio object signals is associated with exactly one of the two or more loudspeaker subset groups.

46. An apparatus according claim 45,
wherein the apparatus is configured to receive said audio signal as an audio input signal,
wherein the processor is configured to decompose the audio input signal into the two or more audio object signals such that the two or more audio object signals represent the signal decomposition of the audio signal into the one or more direct signal components and into the one or more ambient signal components,
wherein the processor is configured to associate each of the two or more audio object signals with exactly one of the two or more loudspeaker subset groups.

47. An apparatus according claim 45,
wherein the apparatus is configured to receive metadata indicating whether an audio object signal of the two or more audio object signals comprises the one or more direct signal components or whether said audio object signal comprises the one or more ambient signal components; and/or
wherein the apparatus is configured to determine whether an audio object signal of the two or more audio object signals comprises the one or more direct signal components or whether said audio object signal comprises the one or more ambient signal components.

48. An apparatus according to claim 34,
wherein the two or more audio object signals represent a signal decomposition of an audio signal into one or more speech signal components and one or more background signal components,
wherein each of the two or more audio object signals is associated with exactly one of the two or more loudspeaker subset groups.

49. An apparatus according claim 48,
wherein the apparatus is configured to receive said audio signal as an audio input signal,
wherein the processor is configured to decompose the audio input signal into the two or more audio object signals such that the two or more audio object signals represent the signal decomposition of the audio signal into the one or more speech signal components and into the one or more background signal components,
wherein the processor is configured to associate each of the two or more audio object signals with exactly one of the two or more loudspeaker subset groups.

50. An apparatus according claim 48,
wherein the apparatus is configured to receive metadata indicating whether an audio object signal of the two or more audio object signals comprises the one or more speech signal components or whether said audio object signal comprises the one or more background signal components; and/or
wherein the apparatus is configured to determine whether an audio object signal of the two or more audio object signals comprises the one or more speech signal components or whether said audio object signal comprises the one or more background signal components.

51. An apparatus according to claim 34,
wherein the apparatus is configured to receive information on that another loudspeaker being different from the two or more loudspeaker indicates its intention to reproducing audio content of the two or more object signals, and wherein, in response to said information, the apparatus is configured to assign said loudspeaker to one or more loudspeaker subset groups of the two or more loudspeaker subset groups depending on one or more capabilities and/or a position of said loudspeaker.

52. An apparatus according to claim 34,
wherein the apparatus is configured to receive information on that one of the two or more loudspeakers is to stop or has stopped reproducing audio content of the two or more object signals, and wherein, in response to said information the processing module is configured to remove said loudspeaker from each of the two or more loudspeaker subset groups to which said loudspeaker has been assigned.

53. An apparatus according to claim 52,
wherein, if said loudspeaker subset group comprises, without the loudspeaker that is to stop or that has stopped reproducing, exactly one loudspeaker of the two or more loudspeakers, the processing module is configured to reassign each of the two or more audio object signals which are associated with said loudspeaker subset group to said exactly one loudspeaker as an assigned signal of the one or more assigned signals of said exactly one loudspeaker, and
wherein, if said loudspeaker subset group comprises, without the loudspeaker that is to stop or that has stopped reproducing, at least two loudspeakers of the two or more loudspeakers, then, for each audio signal component of the two or more audio object signals, the processing module is configured to generate two or more signal portions from said audio object signal and is configured to assign each of the two or more signal portions to a different loudspeaker of said at least two loudspeakers as an assigned signal of the one or more assigned signals of said loudspeaker.

54. An apparatus according to claim 34,
wherein the apparatus is configured to receive information on that the position of one of the two or more loudspeakers has changed, and wherein, in response to said information the processing module is configured to assign said loudspeaker to one or more loudspeaker subset groups of the two or more loudspeaker subset groups depending on the one or more capabilities and/or the position of said one of the two or more loudspeakers.

55. An apparatus according to claim 34,
wherein the processing module is configured to generate a loudspeaker signal for each loudspeaker of at least one of the two or more loudspeakers by combining all loudspeaker component signals of said loudspeaker of all loudspeaker subset groups to which said loudspeaker is assigned.

56. An apparatus according to claim 34,
wherein the apparatus comprises one of the two or more loudspeakers.

57. An apparatus according to claim 56,
wherein the apparatus comprises each of the two or more loudspeakers.

58. An apparatus according to claim 34,
wherein the processing module comprises an apparatus for rendering, wherein the apparatus is configured to generate an audio output signal for a loudspeaker of a loudspeaker setup from one or more audio objects, wherein each of the one or more audio objects comprises an audio object signal and exhibits a position, wherein the apparatus comprises:
an interface configured to receive information on the position of each of the one or more audio objects,
a gain determiner configured to determine gain information for each audio object of the one or more audio objects for the loudspeaker depending on a distance between the position of said audio object and a position of the loudspeaker and depending on distance attenuation information and/or loudspeaker emphasis information, and a signal processor configured to generate an audio output signal for the loudspeaker depending on the audio object signal of each of the one or more audio objects and depending on the gain information for each of the one or more audio objects for the loudspeaker,
wherein, for each loudspeaker subset group of the two or more loudspeaker subset groups, said apparatus of the processing module is configured to generate, for each loudspeaker of said loudspeaker subset group a loudspeaker component signal for each audio object of those of the two or more audio objects which are associated with said loudspeaker subset group depending on a position of said loudspeaker and depending on a position of said audio object.

59. An apparatus according to claim 1,
wherein the apparatus is configured to receive an audio channel signal,
wherein the apparatus is configured to generate an audio object from the audio channel signal by generating an audio object signal from the audio channel signal and by setting a position for the audio object.

60. An apparatus according to claim 34,
wherein the apparatus is configured to receive an audio channel signal,
wherein the apparatus is configured to generate an audio object from the audio channel signal by generating an audio object signal from the audio channel signal and by setting a position for the audio object.

61. An apparatus according to claim 59,
wherein the apparatus is configured to set a position for the audio object depending on a position or an assumed position or a predefined position of a loudspeaker that shall replay or is assumed to replay or is predefined to replay the audio channel signal.

62. An apparatus according to claim 60,
wherein the apparatus is configured to set a position for the audio object depending on a position or an assumed position or a predefined position of a loudspeaker that shall replay or is assumed to replay or is predefined to replay the audio channel signal.

63. An apparatus according to claim 1,
wherein a loudspeaker arrangement comprises three or more loudspeakers,
wherein the apparatus is configured to only employ a proper subset of the three or more loudspeaker for reproducing the audio content of one or more audio objects.

64. An apparatus according to claim 34,
wherein a loudspeaker arrangement comprises three or more loudspeakers,
wherein the apparatus is configured to only employ a proper subset of the three or more loudspeaker for reproducing the audio content of one or more audio objects.

65. An apparatus according to claim 1,
wherein, when reproducing audio content of one or more audio objects, a position defined with respect to a listener moves, when the listener moves.

66. An apparatus according to claim 34,
wherein, when reproducing audio content of one or more audio objects, a position defined with respect to a listener moves, when the listener moves.

67. An apparatus according to claim 1,
wherein, when reproducing audio content of one or more audio objects, a position defined with respect to a listener does not move, when the listener moves.

68. An apparatus according to claim 34,
wherein, when reproducing audio content of one or more audio objects, a position defined with respect to a listener does not move, when the listener moves.

69. A method for rendering, wherein the method comprises generating an audio output signal for a loudspeaker of a loudspeaker setup from one or more audio objects, wherein each of the one or more audio objects comprises an audio object signal and exhibits a position, wherein generating the audio output signal comprises:
receiving information on the position of each of the one or more audio objects,
determining gain information for each audio object of the one or more audio objects for the loudspeaker depending on a distance between the position of said audio object and a position of the loudspeaker and depending on distance attenuation information and/or loudspeaker emphasis information, and
generating an audio output signal for the loudspeaker depending on the audio object signal of each of the one or more audio objects and depending on the gain information for each of the one or more audio objects for the loudspeaker.

70. A method for rendering is provided, wherein the method comprises:
assigning each loudspeaker of the two or more loudspeakers of a loudspeaker setup to one or more loudspeaker subset groups of the two or more loudspeaker subset groups depending on one or more capabilities and/or a position of said loudspeaker, wherein at least one of the two or more loudspeakers is associated with fewer than all of the two or more loudspeaker subset groups,
associating each audio object signal of two or more audio object signals with at least one of two or more loudspeaker subset groups depending on a property of the audio object signal, such that at least one of the two or more audio object signals is associated with fewer than all of the two or more loudspeaker subset groups,
wherein, for each loudspeaker subset group of the two or more loudspeaker subset groups, the method comprises generating for each loudspeaker of said loudspeaker subset group a loudspeaker component signal for each audio object of those of the two or more audio objects which are associated with said loudspeaker subset group depending on a position of said loudspeaker and depending on a position of said audio object,
wherein the method comprises generating a loudspeaker signal for each loudspeaker of at least one of the two or more loudspeakers by combining all loudspeaker component signals of said loudspeaker of all loudspeaker subset groups to which said loudspeaker is assigned.

71. A non-transitory digital storage medium having a computer program stored thereon to perform the method for rendering, wherein the method comprises generating an audio output signal for a loudspeaker of a loudspeaker setup from one or more audio objects, wherein each of the one or more audio objects comprises an audio object signal and exhibits a position, wherein generating the audio output signal comprises:
receiving information on the position of each of the one or more audio objects,
determining gain information for each audio object of the one or more audio objects for the loudspeaker depending on a distance between the position of said audio object and a position of the loudspeaker and depending on distance attenuation information and/or loudspeaker emphasis information, and
generating an audio output signal for the loudspeaker depending on the audio object signal of each of the one or more audio objects and depending on the gain information for each of the one or more audio objects for the loudspeaker,
when said computer program is run by a computer.

72. A non-transitory digital storage medium having a computer program stored thereon to perform the method for rendering is provided, wherein the method comprises:
assigning each loudspeaker of the two or more loudspeakers of a loudspeaker setup to one or more loudspeaker subset groups of the two or more loudspeaker subset groups depending on one or more capabilities and/or a position of said loudspeaker, wherein at least one of the two or more loudspeakers is associated with fewer than all of the two or more loudspeaker subset groups,
associating each audio object signal of two or more audio object signals with at least one of two or more loudspeaker subset groups depending on a property of the audio object signal, such that at least one of the two or more audio object signals is associated with fewer than all of the two or more loudspeaker subset groups,
wherein, for each loudspeaker subset group of the two or more loudspeaker subset groups, the method comprises generating for each loudspeaker of said loudspeaker subset group a loudspeaker component signal for each audio object of those of the two or more audio objects which are associated with said loudspeaker subset group depending on a position of said loudspeaker and depending on a position of said audio object,
wherein the method comprises generating a loudspeaker signal for each loudspeaker of at least one of the two or more loudspeakers by combining all loudspeaker component signals of said loudspeaker of all loudspeaker subset groups to which said loudspeaker is assigned,
when said computer program is run by a computer.
